(19) United States
(12) Patent Application Publication
(10) Pub. No.: US 2024/0087558 A1
(43) Pub. Date: Mar. 14, 2024

(54) METHODS AND SYSTEMS FOR MODIFYING SPEECH GENERATED BY A TEXT-TO-SPEECH SYNTHESISER

(71) Applicant: Spotify AB, Stockholm (SE)

(72) Inventors: Pilar Soledad OPLUSTIL GALLEGOS, Edinburgh (GB); Felix Mathew William Chase VAUGHAN, London (GB); Gerard CARNEY, St Albans (GB); John FLYNN, London (GB); Zeenat QURESHI, London (GB)

(21) Appl. No.: 18/262,242

(22) PCT Filed: Feb. 10, 2022
(86) PCT No.: PCT/GB2022/050366

§ 371 Date: Jul. 20, 2023

(30) Foreign Application Priority Data
Feb. 11, 2021 (GB) 2101923.7

(51) Int. Cl. G10L 13/033; G10L 13/08

(52) U.S. Cl. CPC G10L 13/033; G10L 13/08

(57) ABSTRACT

A method of modifying a speech signal generated by a text-to-speech synthesiser, the method comprising:
receiving a text signal;
generating a speech signal from the text signal;
deriving a control feature vector, wherein the control feature vector represents modifications to the speech signal;
inputting the control feature vector in the text-to-speech synthesiser, wherein the text-to-speech synthesiser is configured to generate a modified speech signal using the control feature vector; and
outputting the modified speech signal.

### FIELD

Embodiments described herein relate to methods and systems for modifying speech generated by a text-to-speech synthesiser.

### BACKGROUND

Text-to-speech (TTS) synthesis methods and systems are used in many applications, for example in devices for navigation and personal digital assistants. TTS synthesis methods and systems can also be used to provide speech segments for games, movies, audio books, or other media comprising speech.

TTS systems often comprise algorithms that need to be trained using training samples. TTS systems are often configured to generate speech signals that have different characteristics or sound different.

There is a continuing need to improve TTS systems and methods for generating speech that have different characteristics.

### BRIEF DESCRIPTION OF FIGURES

Systems and methods in accordance with non-limiting examples will now be described with reference to the accompanying figures in which:

FIG. 1 shows a schematic illustration of a method of modifying a speech signal;

FIG. 2 shows a schematic illustration of another method of modifying a speech signal;

FIG. 3 (a) shows a schematic illustration of a text to speech (TTS) synthesiser;

FIG. 3 (b) shows an example of a schematic illustration of a prediction network used in the synthesiser of FIG. 3 (a);

FIG. 3 (c) shows a schematic illustration of a configuration for training the prediction network of FIG. 3 (b);

FIG. 4 shows a flow chart illustrating the steps for generating a modified speech signal using a TTS system;

FIG. 5 shows a flow chart illustrating a step of FIG. 4 in more detail;

FIG. 6 (a) shows the modification of a pitch track by a user;

FIG. 6 (b) shows an example of modification of the timing of a speech signal by way of a user interface;

FIG. 7 (a) shows a user interface (UI) for modifying properties of a speech signal;

FIG. 7 (b) shows a user interface (UI) for modifying the pitch and intensity of a speech signal;

FIG. 8 (a) shows a shows a schematic illustration of a TTS system comprising a controllable speech model;

FIG. 8 (b) shows a shows a schematic illustration of the training of a TTS system of FIG. 8 (a);

FIG. 9 shows a schematic illustration of a system for modifying a speech signal;

FIG. 10(a) is a schematic showing an example interface for varying the prominence;

FIG. 10(b) shows a flowchart for varying the prominence;

FIG. 11(a) shows an example of a prominence model;

FIG. 11(b) shows an example of training the prominence model;

FIG. 12(a) shows an example of an interface that can be used for varying the intonation of a text input;

FIG. 12 (b) shows an arrangement for varying the intonation;

FIG. 12 (c) shows another arrangement for varying the intonation;

FIG. 13 (a) shows an illustration of an alignment matrix;

FIG. 13 (b) shows a time aligned phoneme pitch for the intonation vector that has been resampled to the decoder timesteps;

FIG. 14 (a) shows a flowchart illustrating the basic steps of the one stage arrangement; and

FIG. 14 (b) shows a single-stage synthesis for the modified intonation vector.

### DETAILED DESCRIPTION

According to a first aspect of the invention, there is provided a method of modifying a speech signal generated by a text-to-speech synthesiser, the method comprising: receiving a text signal;
generating a speech signal from the text signal;
deriving a control feature vector, wherein the control feature vector represents modifications to the speech signal;
inputting the control feature vector in the text-to-speech synthesiser, wherein the text-to-speech synthesiser is configured to generate a modified speech signal using the control feature vector; and
outputting the modified speech signal.

The above allows a user to synthesise speech from text using a standard speech synthesiser text to speech (TTS) model. The system analyses the speech output and extracts acoustic features which can then be used to control and modify the output. The user can modify the acoustic features via a user interface. A vector, incorporating the modified acoustic features, is then input with the text to be synthesised into a further text to speech system (which will be termed the controllable model) and the controllable model outputs modified speech.

In an embodiment, deriving the control feature vector comprises:
analysing the speech signal;
obtaining a first feature vector from the analysed speech signal;
obtaining a user input;
modifying the first feature vector using the user input to obtain the control feature vector.

For example, the user input may be obtained via a user interface. The user input may additionally or alternatively comprise a reference speech signal. For example, the reference speech signal may be a spoken speech signal provided by the user. Using a spoken speech signal as user input enables voice control. For example, the spoken speech signal is obtained by a user recording speech using a microphone. The spoken speech signal is then analyzed to derive a user input and used to modify the first feature vector.

In an embodiment the text-to-speech synthesiser comprises a first model configured to generate the speech signal, and a controllable model configured to generate the modified speech signal. This two-stage workflow allows a user to modify just one or two features of the modified speech. The controllable model may be a trained model.

The controllable model may be trained using speech signals generated by the first model.

The controllable model may comprise an encoder module, a decoder module, and an attention module linking the encoder module to the decoder module. The encoder and decoder may be of the RNN type and so provide a sequence to sequence model.

The first feature vector may be inputted at the decoder module. Prior to inputting the first feature vector into the decoder module, the first feature vector may be modified by a pre-net. The first feature vector may represent one of the properties of pitch or intensity.

In a further embodiment, the method further comprises deriving a second feature vector, wherein the second feature vector represents features of the generated speech signal that are used to generate the modified speech; and
inputting the second feature vector in the text-to-speech synthesiser,
wherein the second feature vector is obtained from the analysed speech signal.

The second feature vector may be derived from the speech signal and not modified prior to input into the controllable model.

The second feature vector may also be inputted at the decoder module of the controllable model.

A representation of the speech signal may also be inputted at the encoder module of the controllable model. For example, an embedding of the speech signal is created as an encoder input.

In an embodiment, the method further comprises deriving a modified alignment from the user input, wherein the modified alignment indicates modifications to the timing of the speech signal. For example, the controllable model has an attention module which comprises an alignment matrix that aligns the encoder input with the decoder output and the modified alignment imposes changes on the alignment matrix.

Deriving a modified alignment may comprise: deriving an alignment from the first model, and then modifying said alignment based on the user input to obtain a modified alignment.

The first model may also comprises an encoder module, a decoder module, and an attention module linking the encoder module to the decoder module.

It is possible to derive a third feature vector from the attention module of the first model, wherein the third feature vector corresponds to the timing of phonemes of the received text signal; and
inputting the third feature vector in the encoder module of the controllable model. The third feature vector is not modified by a user. The third feature vector is passed to the encoder module of the controllable model. The third feature vector is used by the controllable model for generating modified speech.

It is also possible to derive a modified alignment from the attention module of the first model. For example, deriving a modified alignment may comprise: deriving an alignment from the attention module of the first model, and then modifying said alignment based on the user input to obtain a modified alignment.

In further embodiment, there is provided a method of training a text-to-speech synthesiser configured to modify a speech signal generated by the text-to-speech synthesiser. When the text-to-speech synthesiser comprises a first model configured to generate the speech signal, and a controllable model configured to generate the modified speech signal the first model may be pre-trained in advance using standard methods. The pre-trained first model may be used to generate training speech signals and the controllable model may then be trained using training speech signals generated by the first model.

When the first model comprises an encoder module, a decoder module, and an attention module linking the encoder module to the decoder module, the pre-trained first model may be used to generate alignment matrices.

The method of training the text-to-speech synthesiser may comprise training using: a training text signal;
a training speech signal generated from the training text signal using the pre-trained first model;
a training control feature vector derived from the training speech signal; and
an alignment matrix obtained generated by the pre-trained first model for the training text signal.

The method of training may use a training loss function such as a mean squared error. The training loss may be computed by comparing the speech output by the controllable model with the training speech signal generated by the pre-trained first model.

In a further embodiment, a system for modifying a speech signal generated by a text-to-speech synthesiser is provided, the system comprising a processor and a memory, the processor being configured to:
receive a text signal;
generate a speech signal from the text signal;
derive a control feature vector, wherein the control feature vector represents modifications to the speech signal;
input the control feature vector in the text-to-speech synthesiser, wherein the text-to-speech synthesiser is configured to generate a modified speech signal using the control feature vector; and
output the modified speech signal.

The above-described model allows fine grain control of the acoustics of synthesised speech.

The following method is directed towards controlling the overall style. Here, the user inputs text and a ‘prominence vector’ is chosen by user, or by system automatically. The text and prominence vector is then input into a ‘Prominence’ model and speech is output.

In a third aspect, a method of varying the emphasis in a synthesised speech signal generated by a text-to-speech synthesiser is provided to allow parts of the synthesised speech signal to be output with a controllable emphasis, the method comprising:
receiving text to be synthesised;
generating a prominence vector corresponding to said text to be synthesised, said prominence vector indicating parts of said input text which are to be emphasised in said synthesised speech;
inputting the text to be synthesised and the prominence vector into the synthesiser and generating the speech signal with the emphasis controlled by the prominence vector.

The above provides a model which allows overall control of the style for the synthesised speech.

In an embodiment, the prominence vector comprises a time sequence of pitch values, the time sequence corresponding to sequence of phonemes in the input text. The pitch values may be values assigned to frequency bands. In such an arrangement, the frequency bands are determined for each phoneme such that it is possible to determine the average pitch for a phoneme, a high pitch (or prominence) for a phoneme and a low pitch (or prominence) for a phoneme. There can be three bands, for example, 0,1,2 or low, normal, high, but there may be greater or fewer bands. The bands are phoneme dependent, a high prominence for one phoneme may not be the same pitch as a high prominence for a different phoneme.

The speech synthesis model (or “prominence model”) comprises an encoder and decoder linked by attention. The encoder and decoder may be of the RNN type to allow sequence to sequence mapping. The input text may be divided into a sequence of phonemes and the sequence of phonemes are inputted into the encoder, in the form of an input vector where each phoneme represents an encoder timestep.

In an embodiment, the prominence vector is input into the encoder. For example, the prominence vector is concatenated with the output of the encoder prior to the attention network.

In an embodiment, the prominence vector selected from a plurality of pre-set prominence vectors. In a further embodiment, the prominence vector is generated from the text input. A prominence vector may be provide to the user and the pitch values of the prominence vector are modifiable by a user.

In a fourth aspect, a method is provided for training a speech synthesis model which allows parts of the synthesised speech signal to be output with a controllable emphasis, the model comprising:
a text input for receiving text to be synthesised;
a prominence vector input for receiving a prominence vector corresponding to said text to be synthesised, said prominence vector indicating parts of said input text which are to be emphasised in said synthesised speech; and
a model mapping a sequence of input text to a time varying speech signal, the training method comprising:
obtaining training data comprising text and corresponding speech signals;
deriving a pitch track from the corresponding speech signals and obtaining said prominence vector from a time sequence of pitch values derived from said pitch track corresponding to said phonemes; and
training said model using said text and corresponding prominence vector as inputs and said speech signal as an output.

In the above, obtaining the prominence vector for a text input may comprise:
obtaining, for each phoneme in the training data set, an average value for the pitch of each phoneme and the range of pitch for each phoneme;
assigning n frequency bands to each phoneme based on the an average value for the pitch of each phoneme and the range of pitch for each phoneme, where n is an integer having a value of at least two;
deriving a pitch track from the corresponding speech signals for said text input, determining the average pitch for each phoneme in the text input and assigning a value derived from an index of the frequency bands for each phoneme to produce said prominence vector.

The speech signals used to train the model may be synthesised speech signals.

In a further aspect, a system is provided for varying the emphasis in a synthesised speech signal generated by a text-to-speech synthesiser to allow parts of the synthesised speech signal to be output with a controllable emphasis, the system comprising a processor and a memory, the processor being configured to:
receive text to be synthesised;
generate a prominence vector corresponding to said text to be synthesised, said prominence vector indicating parts of said input text which are to be emphasised in said synthesised speech; and
input the text to be synthesised and the prominence vector into the synthesiser and generating the speech signal with the emphasis controlled by the prominence vector.

In a further aspect, a system is provided for training a speech synthesis model which allows parts of the synthesised speech signal to be output with a controllable emphasis, the model comprising:
a text input for receiving text to be synthesised;
a prominence vector input for receiving a prominence vector corresponding to said text to be synthesised, said prominence vector indicating parts of said input text which are to be emphasised in said synthesised speech; and
a model mapping a sequence of input text to a time varying speech signal, the system further comprising:
obtaining training data comprising text and corresponding speech signals;
deriving a pitch track from the corresponding speech signals and obtaining said prominence vector from a time sequence of pitch values derived from said pitch track corresponding to said phonemes; and
training said model using said text and corresponding prominence vector as inputs and said speech signal as an output.

In the above methods, data is automatically analysed to extract ‘prominence’ features. In an embodiment, a speaker's full dataset is analysed to establish global values for that speaker and these global values to decide if the individual line has a prominence peak (value in a high frequency band for that phoneme).

Finally a third method will be discussed where the level of control is between the fine control of the first method, but finer than the overall style control provided by the second method.

In a yet further aspect, a method is provided of varying the intonation in a synthesised speech signal generated by a first speech synthesis model to allow parts of the synthesised speech signal to be output with a controllable intonation, the method comprising:
receiving text to be synthesised;
generating an intonation vector corresponding to said text to be synthesised, said intonation vector indicating the intonation that said input text is to be output as synthesised speech;
inputting the text to be synthesised and the intonation vector into the first speech synthesis model and generating the speech signal with the intonation controlled by the intonation vector.

The above method can be implemented as two stage process or a single stage process. For the two-stage process, generating the intonation vector comprises:
synthesising speech from the received text using a second speech synthesis model;
obtaining a pitch track from synthesised speech;
determining the average pitch of each phoneme and generating a pitch vector; and
varying the pitches of one or more phonemes to produce an intonation vector.

As for the above first and second methods, the first speech synthesis model comprises an encoder and decoder linked by an attention mechanism. The encoder and decoder may be of the RNN type to allow sequence to sequence mapping. The input text may be divided into a sequence of phonemes and the sequence of phonemes are inputted into the encoder, in the form of an input vector where each phoneme represents an encoder timestep.

In an embodiment, the intonation vector is input to the decoder. To allow the intonation vector to be input into the decoder it may be upsampled from the encoder timesteps to the timesteps of the decoder input.

The second speech synthesis model may also comprise an encoder and decoder linked by an attention mechanism. The encoder and decoder may be of the RNN type to allow sequence to sequence mapping. The attention mechanism of the second speech synthesis model comprises an alignment matrix that aligns the encoder timesteps and decoder timesteps and the intonation vector may be upsampled from the encoder timesteps to the decoder timesteps using the alignment matrix.

During synthesis of the modified speech, the alignment matrix of the second speech synthesis model may be forced on the alignment matrix of the attention network of the first speech synthesis model.

The third method may also be implemented as a single stage method where said intonation vector comprises receiving a vector with a pitch allocated to each phoneme of the input text and the user selects the pitch for at least one phoneme.

In a further aspect, a method is provided of training a speech synthesis model which allows parts of the synthesised speech signal to be output with controllable intonation, the model comprising:
a text input for receiving text to be synthesised;
an intonation vector input for receiving an intonation vector corresponding to said text to be synthesised, said intonation vector indicating the intonation that said input text is to be output as synthesised speech; and
a first speech synthesis model mapping a sequence of input text to a time varying speech signal, the training method comprising:
obtaining training data comprising text and corresponding speech signals;
deriving a pitch track from the corresponding speech signals and obtaining said intonation vector from a time sequence of pitch values derived from said pitch track corresponding to said phonemes; and
training said model using said text and corresponding intonation vector as inputs and said speech signal as an output.

The first speech synthesis model comprises an encoder and decoder linked by an attention mechanism and the intonation vector may be upsampled to timesteps of the decoder and is input into the decoder. The training data may be derived from a second speech synthesis model that comprises an encoder and decoder linked by an attention mechanism, wherein the attention mechanism comprises an alignment matrix that aligns the encoder timesteps and decoder timesteps and said intonation vector is upsampled from the encoder timesteps to the decoder timesteps using the alignment matrix of the second speech synthesis model.

In a further aspect, a system is provided for varying the intonation in a synthesised speech signal generated by a first speech synthesis model to allow parts of the synthesised speech signal to be output with a controllable intonation, the system comprising a processor and a memory, the processor being configured to:
receive text to be synthesised;
generate an intonation vector corresponding to said text to be synthesised, said intonation vector indicating the intonation that said input text is to be output as synthesised speech; and
input the text to be synthesised and the intonation vector into the first speech synthesis model and generating the speech signal with the intonation controlled by the intonation vector.

In a further aspect, a system is provided for training a speech synthesis model which allows parts of the synthesised speech signal to be output with controllable intonation, the model comprising:
a text input for receiving text to be synthesised;
an intonation vector input for receiving an intonation vector corresponding to said text to be synthesised, said intonation vector indicating the intonation that said input text is to be output as synthesised speech; and
a first speech synthesis model mapping a sequence of input text to a time varying speech signal,
   the system comprising a processor and a memory, the processor being configured to:
obtain training data comprising text and corresponding speech signals;
derive a pitch track from the corresponding speech signals and obtaining said intonation vector from a time sequence of pitch values derived from said pitch track corresponding to said phonemes; and
train said model using said text and corresponding intonation vector as inputs and said speech signal as an output.

Methods in accordance with embodiments described herein provide a method of modifying the speech generated by a trained TTS system. Training of TTS systems is time consuming and requires large training datasets. The methods described herein enable the output speech that would be generated by a trained TTS system to be modified. The modification is performed at inference, without additional training of the TTS system. The methods enable modification of the speech signal while maintaining the accuracy and quality of the trained TTS system.

The methods are computer-implemented methods. Since some methods in accordance with examples can be implemented by software, some examples encompass computer code provided to a general purpose computer on any suitable carrier medium. The carrier medium can comprise any storage medium such as a floppy disk, a CD ROM, a magnetic device or a programmable memory device, or any transient medium such as any signal e.g. an electrical, optical or microwave signal. The carrier medium may comprise a non-transitory computer readable storage medium.

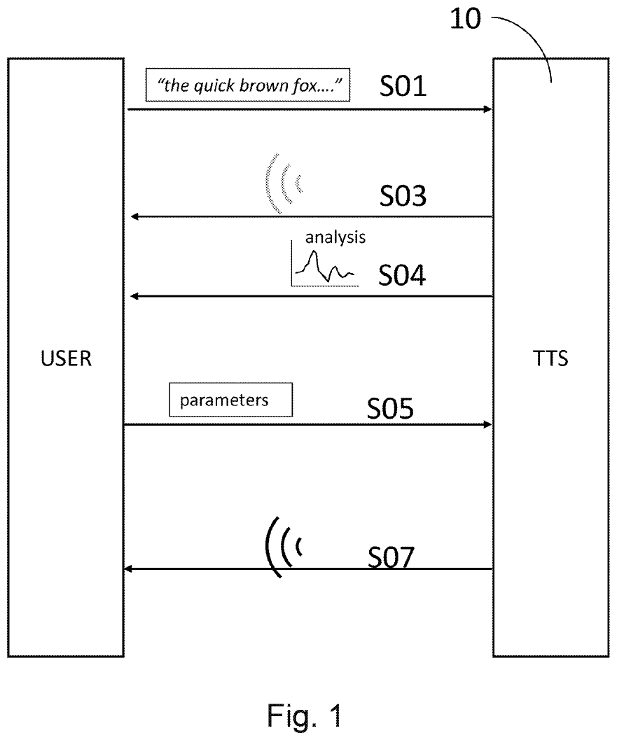

FIG. 1 shows a schematic illustration of a method of modifying a speech signal. In S01, a user provides input text which is provided to a text-to-speech (TTS) system 1. The input text can be provided via an input device such as a keyboard, the user may also select the input text from one or more possible options provided to them. For example, if the user is reviewing the quality of synthesised speech produced from a book, script etc, the user may be provided an option to select the text corresponding synthesised speech to be modified. The TTS system 10 is configured to convert the text signal that is inputted into a speech signal. In S03, the speech signal is provided to the user. Note that the speech signal may be an audio file of synthesised speech and/or information that enables generation of audible speech. The speech may be played back to the user as an audible sound, and/or a representation of the speech signal may be shown to the user. The TTS system 10 is also configured to analyse the text signal and/or the speech signal. How the analysis is performed will be described in more detail below. In S04, the analysed data is provided to the user. In S05, parameters from the user is inputted into the TTS 10. The parameters from the user reflects modifications to the speech signal. In S07, the TTS 10 is configured to output a modified speech signal.

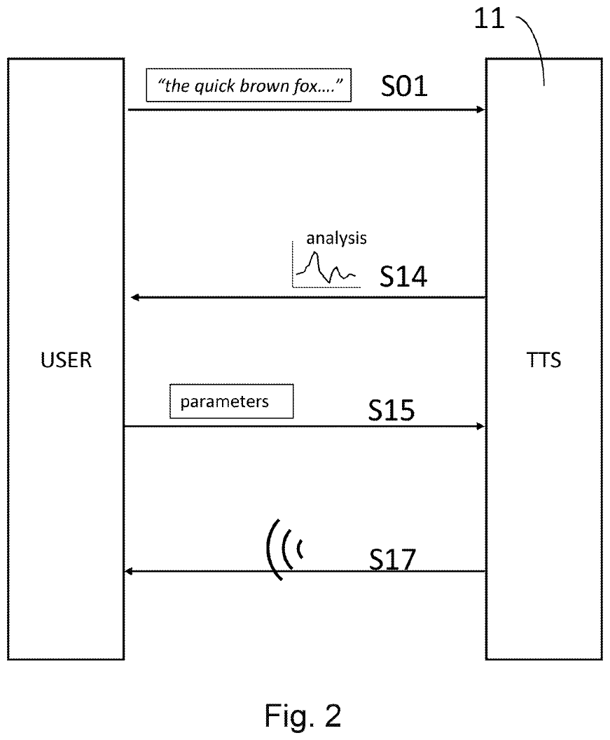

FIG. 2 shows a schematic illustration of a method of modifying a speech signal. In S01, a user provides input text that is provided to a text-to-speech (TTS) system 11. The TTS system 11 is configured to analyse the text signal and/or the speech signal. How the analysis is performed will be described in more detail below. In S14, the analysed data is provided to the user. In S15, parameters from the user is inputted into the TTS 11. The parameters from the user reflects modifications to the speech signal. In S17, the TTS 11 is configured to output a modified speech signal.

In the methods of FIGS. 1 and 2, some of the steps may be performed on the TTS system 10 or 11, while others are performed on a user terminal (not shown). For example, steps that may be carried out on the user terminal include receipt of the analysis S04, S14, modification of parameters S05, S15 that are sent to the TTS, and receipt of speech signals for playback S03, S07, and S17. Other steps such as synthesis of a first audio sample S03, or synthesis of a modified speech signal S07, S17, analysis of the speech and/or text signal to for delivery to the user S04, S14, or derivation of modifications from the parameters provided by the user S05, S15 are performed on the TTS system.

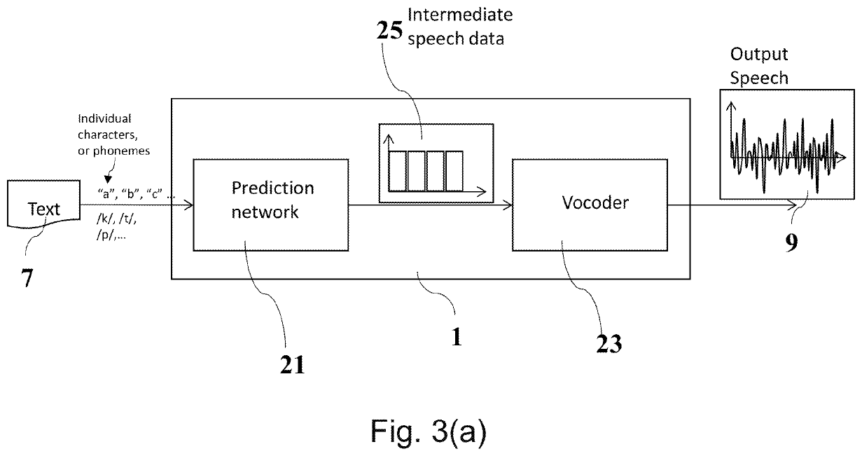

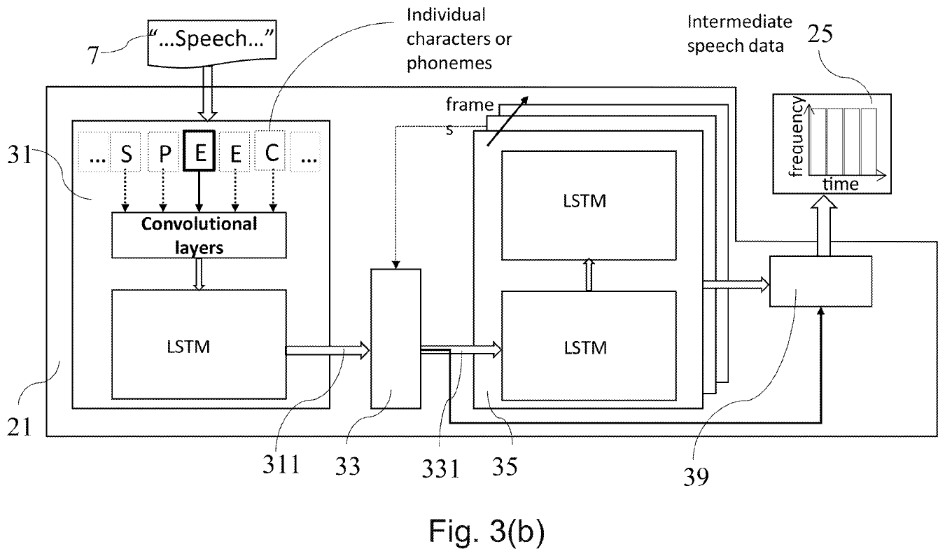

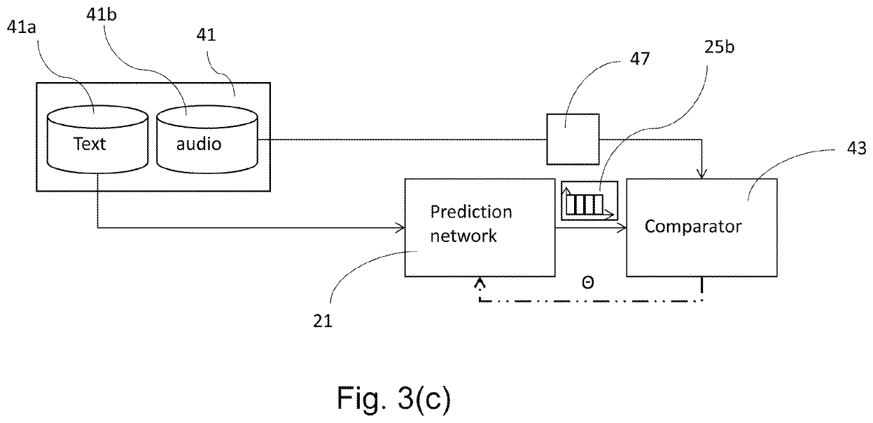

FIG. 3 (a) shows a schematic illustration of a text to speech synthesiser 1 for generating speech 9 from text 7. The synthesiser 1 can be trained to generate speech. The generated speech may have a speech attribute. A speech attribute may comprise emotions such as sadness, anger, happiness, etc . . . ; and/or intentions such as sarcasm; and/or a different projections such as a whisper, a shout; and/or different paces; and/or different accents such as French, British English, American English, etc. . . . . A speech attribute (also referred to as an attribute) refers to how the generated speech is perceived by a human listener.

The system comprises a prediction network 21 configured to convert input text 7 into speech data 25. The speech data 25 is also referred to as the intermediate speech data 25. The system further comprises a Vocoder that converts the intermediate speech data 25 into an output speech 9. The prediction network 21 comprises a neural network (NN). The Vocoder also comprises a NN.

The prediction network 21 receives a text input 7 and is configured to convert the text input 7 into an intermediate speech data 25. The intermediate speech data 25 comprises information from which an audio waveform may be derived. The intermediate speech data 25 may be highly compressed while retaining sufficient information to convey vocal expressiveness. The generation of the intermediate speech data 25 will be described further below in relation to FIG. 2.

The text input 7 may be in the form of a text file or any other suitable text form such as ASCII text string. The text may be in the form of single sentences or longer samples of text. A text front-end, which is not shown, converts the text sample into a sequence of individual characters (e.g. “a”, “b”, “c”, . . . ). In another example, the text front-end converts the text sample into a sequence of phonemes (/k/, /t/, /p/, . . . ). Phonemes are units of sound that distinguish a word from another in a particular language. For example, in English, the phonemes /p/, /b/, /d/, and/t/occur in the words pit, bit, din, and tin respectively for example.

The intermediate speech data 25 comprises data encoded in a form from which a speech sound waveform can be obtained. For example, the intermediate speech data may be a frequency domain representation of the synthesised speech. In a further example, the intermediate speech data is a spectrogram. A spectrogram may encode a magnitude of a complex number as a function of frequency and time. In a further example, the intermediate speech data 25 may be a mel spectrogram. A mel spectrogram is related to a speech sound waveform in the following manner: a short-time Fourier transform (STFT) is computed over a finite frame size, where the frame size may be 50 ms, and a suitable window function (e.g. a Hann window) may be used; and the magnitude of the STFT is converted to a mel scale by applying a non-linear transform to the frequency axis of the STFT, where the non-linear transform is, for example, a logarithmic function.

The Vocoder module takes the intermediate speech data 25 as input and is configured to convert the intermediate speech data 25 into a speech output 9. The speech output 9 is an audio file of synthesised speech and/or information that enables generation of speech. The Vocoder module will be described further below.

Alternatively, the intermediate speech data 25 is in a form from which an output speech 9 can be directly obtained. In such a system, the Vocoder 23 is optional.

FIG. 3 (b) shows a schematic illustration of the prediction network 21 according to a non-limiting example. It will be understood that other types of prediction networks that comprise neural networks (NN) could also be used.

The prediction network 21 comprises an Encoder 31, an attention network 33, and decoder 35. As shown in FIG. 3 (b), the prediction network maps a sequence of characters to intermediate speech data 25. In an alternative example which is not shown, the prediction network maps a sequence of phonemes to intermediate speech data 25. In an example, the prediction network is a sequence to sequence model. A sequence to sequence model maps a fixed length input from one domain to a fixed length output in a different domain, where the length of the input and output may differ.

The Encoder 31 takes as input the text input 7. The encoder 31 comprises a character embedding module (not shown) which is configured to convert the text input 7, which may be in the form words, sentences, paragraphs, or other forms, into a sequence of characters. Alternatively, the encoder may convert the text input into a sequence of phonemes. Each character from the sequence of characters may be represented by a learned 512-dimensional character embedding. Characters from the sequence of characters are passed through a number of convolutional layers. The number of convolutional layers may be equal to three for example. The convolutional layers model longer term context in the character input sequence. The convolutional layers each contain 512 filters and each filter has a 5×1 shape so that each filer spans 5 characters. To the outputs of each of the three convolutional layers, a batch normalization step (not shown) and a ReLU activation function (not shown) are applied. The encoder 31 is configured to convert the sequence of characters (or alternatively phonemes) into encoded features 311 which is then further processed by the attention network 33 and the decoder 35.

The output of the convolutional layers is passed to a recurrent neural network (RNN). The RNN may be a long-short term memory (LSTM) neural network (NN). Other types of RNN may also be used. According to one example, the RNN may be a single bi-directional LSTM containing 512 units (256 in each direction). The RNN is configured to generate encoded features 311. The encoded features 311 output by the RNN may be a vector with a dimension k.

The Attention Network 33 is configured to summarize the full encoded features 311 output by the RNN and output a fixed-length context vector 331. The fixed-length context vector 331 is used by the decoder 35 for each decoding step. The attention network 33 may take information (such as weights) from previous decoding steps (that is, from previous speech frames decoded by decoder) in order to output a fixed-length context vector 331. The function of the attention network 33 may be understood to be to act as a mask that focusses on the important features of the encoded features 311 output by the encoder 31. This allows the decoder 35, to focus on different parts of the encoded features 311 output by the encoder 31 on every step. The output of the attention network 33, the fixed-length context vector 331, may have dimension m, where m may be less than k. According to a further example, the Attention network 33 is a location-based attention network.

Additionally or alternatively, the attention network 33 takes as input an encoded feature vector 311 denoted as h={h1, h2, . . . , hk}. A(i) is a vector of attention weights (called alignment). The vector A(i) is generated from a function attend(s(i−1), A(i−1), h),_where s(i−1) is a previous decoding state and A(i−1) is a previous alignment. s(i−1) is 0 for the first iteration of first step. The attend( ) function is implemented by scoring each element in h separately and normalising the score. G(i) is computed from G(i)=Σ^{k} A(i,k)×hₖ. G(i) is the context vector. The output of the attention network 33 is generated as Y(i)=generate(s(i−1), G(i)), where generate( ) may be implemented using a recurrent layer of 256 gated recurrent units (GRU) units for example. The attention network 33 also computes a new state s(i)=recurrency(s(i−1), G(i), Y(i)), where recurrency( ) is implemented using LSTM.

The decoder 35 is an autoregressive RNN which decodes information one frame at a time. The information directed to the decoder 35 is be the fixed length context vector 331 from the attention network 33. In another example, the information directed to the decoder 35 is the fixed length context vector 331 from the attention network 33 concatenated with a prediction of the decoder 35 from the previous step. In each decoding step, that is, for each frame being decoded, the decoder may use the results from previous frames as an input to decode the current frame. In an example, as shown in FIG. 3 (b), the decoder autoregressive RNN comprises two uni-directional LSTM layers with 1024 units. The prediction from the previous time step is first passed through a small pre-net (not shown) containing 2 fully connected layers of 256 hidden ReLU units. The output of the pre-net, and the attention context vector are concatenated and then passed through the two uni-directional LSTM layers. The output of the LSTM layers is directed to a predictor 39 where it is concatenated with the fixed-length context vector 331 from the attention network 33 and projected trough a linear transform to predict a target mel spectrogram. The predicted mel spectrogram is further passed through a 5-layer convolutional post-net which predicts a residual to add to the prediction to improve the overall reconstruction. Each post-net layer is comprised of 512 filters with shape 5×1 with batch normalization, followed by tanh activations on all but the final layer. The output of the predictor 39 is the speech data 25.

The parameters of the encoder 31, decoder 35, predictor 39 and the attention weights of the attention network 33 are the trainable parameters of the prediction network 21.

According to another example, the prediction network 21 comprises an architecture according to Shen et al. “Natural tts synthesis by conditioning wavenet on mel spectrogram predictions.” 2018 IEEE International Conference on Acoustics, Speech and Signal Processing (ICASSP). IEEE, 2018.

Returning to FIG. 3 (a), the Vocoder 23 is configured to take the intermediate speech data 25 from the prediction network 21 as input, and generate an output speech 9. In an example, the output of the prediction network 21, the intermediate speech data 25, is a mel spectrogram representing a prediction of the speech waveform.

According to an embodiment, the Vocoder 23 comprises a convolutional neural network (CNN). The input to the Vocoder 23 is a frame of the mel spectrogram provided by the prediction network 21 as described above in relation to FIG. 3 (a). The mel spectrogram 25 may be input directly into the Vocoder 23 where it is inputted into the CNN. The CNN of the Vocoder 23 is configured to provide a prediction of an output speech audio waveform 9. The predicted output speech audio waveform 9 is conditioned on previous samples of the mel spectrogram 25. The output speech audio waveform may have 16-bit resolution. The output speech audio waveform may have a sampling frequency of 24 kHz.

Alternatively, the Vocoder 23 comprises a convolutional neural network (CNN). The input to the Vocoder 23 is derived from a frame of the mel spectrogram provided by the prediction network 21 as described above in relation to FIG. 3 (b). The mel spectrogram 25 is converted to an intermediate speech audio waveform by performing an inverse STFT. Each sample of the speech audio waveform is directed into the Vocoder 23 where it is inputted into the CNN. The CNN of the Vocoder 23 is configured to provide a prediction of an output speech audio waveform 9. The predicted output speech audio waveform 9 is conditioned on previous samples of the intermediate speech audio waveform. The output speech audio waveform may have 16-bit resolution. The output speech audio waveform may have a sampling frequency of 24 kHz.

Additionally or alternatively, the Vocoder 23 comprises a WaveNet NN architecture such as that described in Shen et al. “Natural tts synthesis by conditioning wavenet on mel spectrogram predictions.” 2018 IEEE International Conference on Acoustics, Speech and Signal Processing (ICASSP). IEEE, 2018.

Additionally or alternatively, the Vocoder 23 comprises a WaveGlow NN architecture such as that described in Prenger et al. “Waveglow: A flow-based generative network for speech synthesis.” ICASSP 2019-2019 IEEE International Conference on Acoustics, Speech and Signal Processing (ICASSP). IEEE, 2019.

Alternatively, the Vocoder 23 comprises any deep learning based speech model that converts an intermediate speech data 25 into output speech 9.

According to another alternative embodiment, the Vocoder 23 is optional. Instead of a Vocoder, the prediction network 21 further comprises a conversion module (not shown) that converts intermediate speech data 25 into output speech 9. The conversion module may use an algorithm rather than relying on a trained neural network. In an example, the Griffin-Lim algorithm is used. The Griffin-Lim algorithm takes the entire (magnitude) spectrogram from the intermediate speech data 25, adds a randomly initialised phase to form a complex spectrogram, and iteratively estimates the missing phase information by: repeatedly converting the complex spectrogram to a time domain signal, converting the time domain signal back to frequency domain using STFT to obtain both magnitude and phase, and updating the complex spectrogram by using the original magnitude values and the most recent calculated phase values. The last updated complex spectrogram is converted to a time domain signal using inverse STFT to provide output speech 9.

FIG. 3 (c) shows a schematic illustration of a configuration for training the prediction network 21 according to a comparative example. The prediction network 21 is trained independently of the Vocoder 23. According to an example, the prediction network 21 is trained first and the Vocoder 23 is then trained independently on the outputs generated by the prediction network 21.

According to an example, the prediction network 21 is trained from a first training dataset 41 of text data 41a and audio data 41b pairs as shown in FIG. 3 (c). The Audio data 41b comprises one or more audio samples. In this example, the training dataset 41 comprises audio samples from a single speaker. In an alternative example, the training set 41 comprises audio samples from different speakers. When the audio samples are from different speakers, the prediction network 21 comprises a speaker ID input (e.g. an integer or learned embedding), where the speaker ID inputs correspond to the audio samples from the different speakers. In the figure, solid lines (-) represent data from a training sample, and dash-dot-dot-dash (- · · -) lines represent the update of the weights Θ of the neural network of the prediction network 21 after every training sample. Training text 41a in fed in to the prediction network 21 and a prediction of the intermediate speech data 25b is obtained. The corresponding audio data 41b is converted using a converter 47 into a form where it can be compared with the prediction of the intermediate speech data 25b in the comparator 43. For example, when the intermediate speech data 25b is a mel spectrogram, the converter 47 performs a STFT and a non-linear transform that converts the audio waveform into a mel spectrogram. The comparator 43 compares the predicted first speech data 25b and the converted audio data 41b. According to an example, the comparator 43 may compute a loss metric such as a cross entropy loss given by: —(actual converted audio data) log (predicted first speech data). Alternatively, the comparator 43 may compute a loss metric such as a mean squared error. The gradients of the error with respect to the weights Θ of the prediction network may be found using a back propagation through time algorithm. An optimiser function such as a gradient descent algorithm may then be used to learn revised weights Θ. Revised weights are then used to update (represented by - · · - in FIG. 3 (c)) the NN model in the prediction network 21.

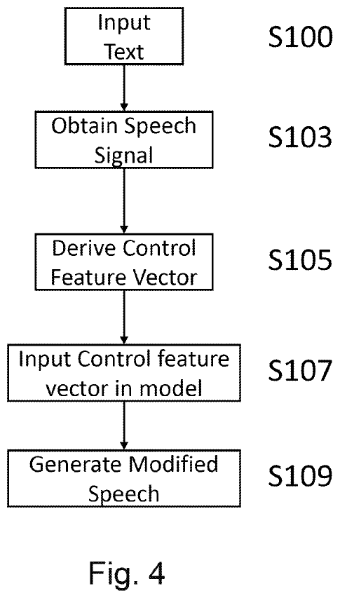

FIG. 4 shows a flow chart illustrating the steps for generating a modified speech signal using a TTS system. The method of FIG. 4 enables fine-grained control of the acoustics. By fine-grained control, what is meant is that specific parts of the generated speech signal may be modified, while leaving the remaining parts unchanged. For example, the intensity and/or pitch of a particular part of the speech signal may be modified.

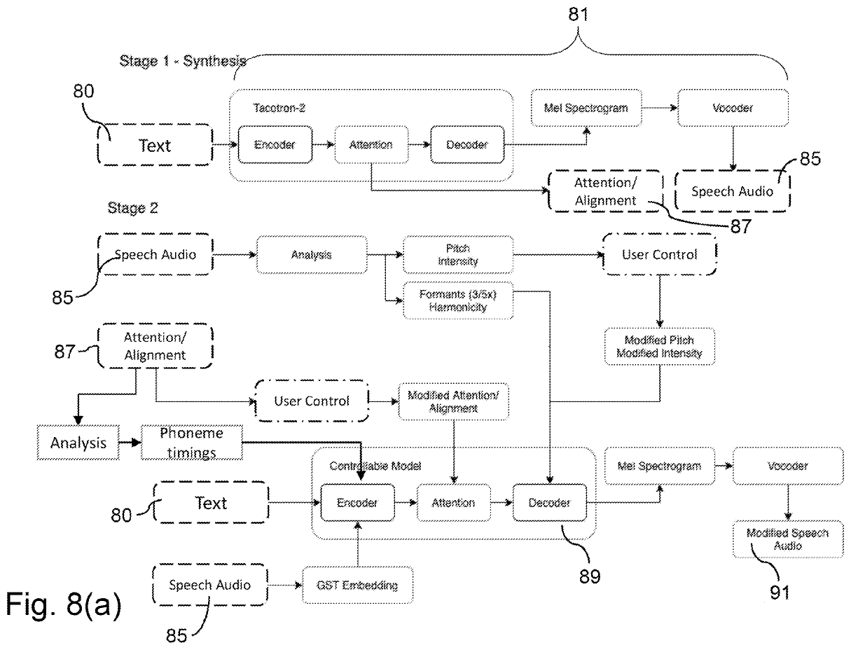

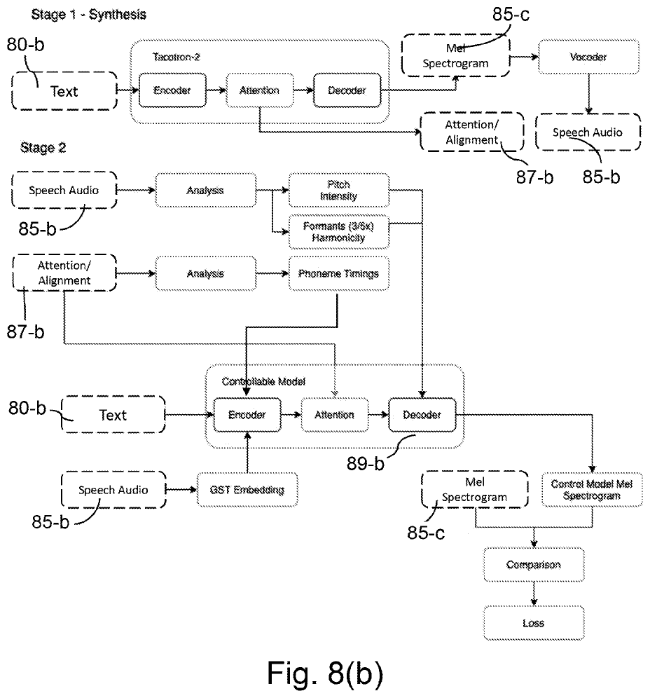

The TTS system comprises synthesisers similar to that described in relation to FIG. 3(a) to 3(b) and will be described further below in relation to FIGS. 8(a) and 8(b). In S100, a text signal is inputted. In S103, a speech signal is obtained from the text signal using the TTS system. In S105, a control feature vector is derived. The control feature vector refers to a vector that can be inputted into the TTS system to modify the speech signal that is subsequently generated. The control feature vector is derived from one or more of the text signal, the speech signal, and parameters provided by a user. How the control feature vector is derived will be described in more detail below. In S107, the control feature vector is inputted into a model of the TTS system. In S109, the TTS system generates a modified speech signal.

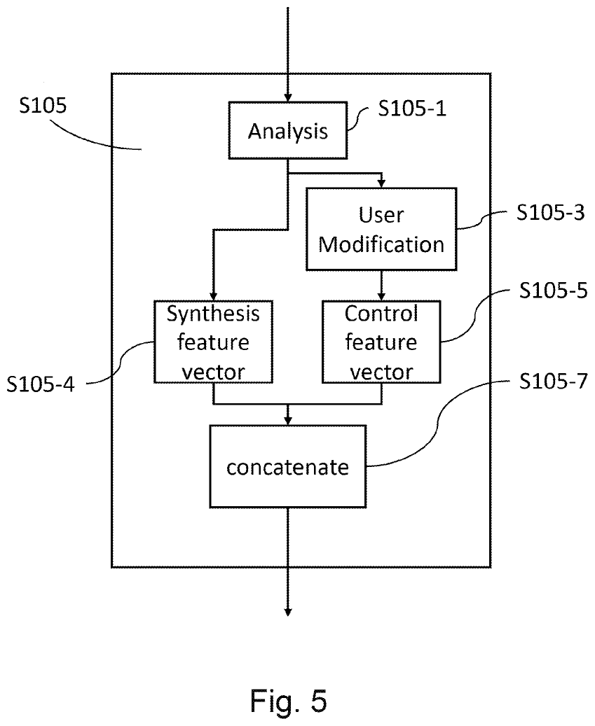

FIG. 5 shows a flow chart illustrating how a control feature vector is derived in S105 of FIG. 4. In S105-1, the speech signal obtained in S103 of FIG. 4 is analysed. The analysis in S105-1 relates to the extraction of one or more properties of the obtained speech signal. The properties comprise the following: pitch, intensity, formants, and harmonicity.

The pitch of a speech signal has units of Hz and relates to the relative highness or lowness of a tone as perceived by the ear. The pitch is related to the fundamental frequency (f₀) of a signal. f₀ may be used to approximate the pitch.

The f₀ of the speech signal may be obtained using, for example, the following steps:
1) Split the audio signal into small chunks or “analysis windows”—the width of the windows is chosen to match the duration that each Mel frame represents. For example, when the mels are extracted every 0.0116 seconds, the width of the analysis windows is chosen to be 0.0116 seconds. Additionally and optionally, the “analysis windows” may be overlapping when the mel frames overlap. The analysis windows correspond to the position and duration of the mel frames. For example, if the Mel frames overlap by a quarter of the total window length (e.g. when the mel frame has a width of 0.0116 seconds, the overlap is 0.0029 seconds).
2) For each of these windows apply a filter e.g. The Hanning Filter or Gaussian filter, where each sample in the audio signal is multiplied by the corresponding value of the filter function.
3) Divide this filtered audio signal by the normalised autocorrelation curve of the filter function (e.g. Hanning or Gaussian).
4) Find the position of the peak in the result of the above in terms of number of samples. Convert the position into frequency using the equation f₀=1/(Peak_Position/Sample_Rate). Thus, a value of f₀ is obtained for each of the analysis windows (which correspond to the number of mel frames).

The intensity of a speech signal has units of dB. The intensity relates to the relative loudness of the speech signal, as perceived by the human ear. The intensity may be obtained by:
1) taking the square of the sample values of the speech signal;
2) convolving with a Gaussian analysis window In an example, the effective duration of the analysis window is 3.2/(minimum_pitch). For example, when the minimum pitch is 10 Hz, then the analysis window is 0.32 seconds. In another example, the analysis windows are taken to be the same windows used to compute the Mel frames, including overlapping windows when the mel frame windows overlap.

The intensity of the speech signal has the form of a vector (an intensity vector). The vector has a length that corresponds to the number of Mel frames. Each element of the vector is obtained from the mean value of the intensity over the time window each Mel Frame corresponds to. For example, when the Mel frames are 0.0116 seconds long and overlap by 0.0029 seconds, then the mean is obtained over each of those time windows.

Formants relate to how energy is concentrated around distinctive frequency components in a speech signal. Formants may be visualised as peaks in the frequency spectrum of the speech signal. Formants correspond to resonances in the human vocal tract. A speech signal may be characterised by its formants. In an example, three formants (F1, F2, F3) are used to characterise the speech signal. In a further example, five formants (F1, F2, F3, F4, F5) are used to characterise the speech signal. By using five formants, the quality of the generated speech signal may be improved. The formants may be obtained using the following steps:
1) Taking segments or analysis windows of the audio signal. The width of the analysis windows is chosen to match the windows used to compute the Mel frames. Additionally and optionally, the analysis windows may be overlapping when the Mel frames overlap. The analysis windows correspond to the position and duration of the Mel frames. For example, if the Mel frames overlap by a quarter of the total window length then. when the mel frame has a width of 0.0116 seconds, the overlap is 0.0029 seconds.
2) For each of these analysis windows, multiply by a window function e.g. the Hamming window function.
3) Apply a pre-emphasis filter, for example a high pass filter.
4) Obtain the coefficients of a linear predictor. The order of the linear predictor is selected to be two times the expected number of formants plus two. For example, when three formants are sought, the linear predictor order is set to 8.
5) Obtain the roots of the linear predictor from the coefficients of the linear predictor. As the coefficients of the linear predictor is real valued, the roots occur in complex conjugate pairs. Select only one root of the each pair (e.g. the root with a positive imaginary part) and determine the angle corresponding to these roots.
6) Convert the angle of the roots from rad/sample to Hz. Calculate the bandwidth of the formant, which correspond to the distance of the zeros of the linear predictor from the unit circle. The angle of the roots, in Hz, that have a corresponding bandwidth less than, e.g. 400 Hz, correspond to the formants.

Harmonicity relates to the periodicity of a speech signal and has units of dB. Harmonicity is also referred to as Harmonics-to-Noise Ratio (HNR). HNR is a measure of how much energy of a signal is in the harmonic part, in relation to the amount of energy that is noise. The harmonicity may be obtained using the following steps:
1) window the sound—the width of the windows is chosen to match the duration that each Mel frame represents. For example, when the mels are extracted every 0.0116 seconds, the width of the analysis windows is chosen to be 0.0116 seconds.
2) For each window compute the autocorrelation r(t) as a function of the lag time, t.
3) Find the position of highest maxima (outside the maxima at t=0), and record this as t_max
4) Compute the normalised autocorrelation function r′(t)=r(t)/r(0)
5) The HNR in dB is then given by A*log(r′(t_max)/1−r′(t_max)) (where A is a prefactor to convert to dB)

The decoder time steps (num_decoder_timesteps) match up to a fixed number of Mel frames. In an example, the matching is one to one, i.e. num_decoder_timesteps corresponds to the number of Mel frames.

The above properties are extracted at the same rate as the mel spectrograms generated by the TTS system. In an example, the mels are extracted every 0.0116 seconds. Using the same rate ensures that the control feature vector of S105 in FIG. 4 has the same length as the number of frames of the resulting speech signal. The control feature vector has a dimension of 1× num_decoder_timesteps, where num_decoder_timesteps corresponds to how many Mel frames the resulting audio has.

From the analysis step of S105-1, two properties are obtained. As mentioned above, the properties are extracted at the same rate as the mels output by the TTS and correspond to feature vectors each having a length 1× num_decoder_timesteps.

In S105-5 a control feature vector is obtained. The control feature vector is modified by a user in S105-3. In S105-3, the user receives a property from S105-1 and modifies said property. The control feature vector may be derived from any one of the properties of pitch, intensity, formants, and harmonicity. In an example, the control feature vector is selected from pitch or intensity. The purpose of the control feature vector is to enable controllability of the speech that is generated.

In S105-4 a synthesis feature vector is obtained. The synthesis feature vector is not modified by a user and obtained directly from the analysis of S105-1. The synthesis feature vector comprises any one of the properties of formant or harmonicity. The purpose of the synthesis feature vector is to improve the quality of the modified speech signal that is subsequently generated. How this is achieved will be discussed below in relation to FIG. 8.

In S105-7, the control feature vector and the synthesis feature vector are concatenated to an input of the model in S107 of FIG. 4.

Although FIG. 5 and the above description describe how two properties are analysed in S105-1 and used to obtain a control feature vector and a synthesis feature vector, it will be understood that one or more control feature vectors and/or one or more synthesis feature vector may be used. In other words, more than two properties may be analysed to obtain more than two vectors. These vectors may concatenated to an input of the model in S105-7.

In an example, a pitch and an intensity attribute are obtained and modified by a user to form two control feature vectors. A formant and a harmonicity attribute are obtained but left unmodified to form two synthesis feature vectors. These vectors are then concatenated at an input of the model in S105-7.

Additionally and optionally, any of the feature vectors may be modified by a pre-net (not shown in FIG. 5). When more than one feature vector is inputted, each feature vector is modified through a separate pre-net and the output of each pre-net is concatenated at an input of the model in S105-7. Each pre-net receives a feature vector as input and outputs a vector of the same size. The purpose of the pre-net is to pre-process the feature vectors and present it in a form that is more readable to the model. The pre-net is part of the model and is trained together with the model. The pre-net comprises one or more 1D linear or convolutional layers with, for example, a 5×1 kernel size. In an example, the pre-net comprises three layers. In another example, when the pre-net comprises convolutional layers, the pre-net comprises 5 layers each with 5×1 kernel size.

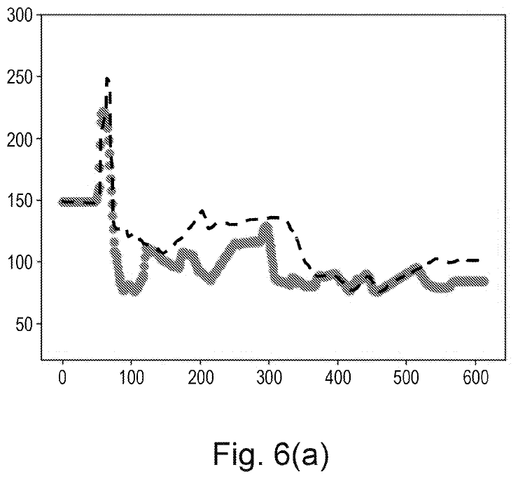

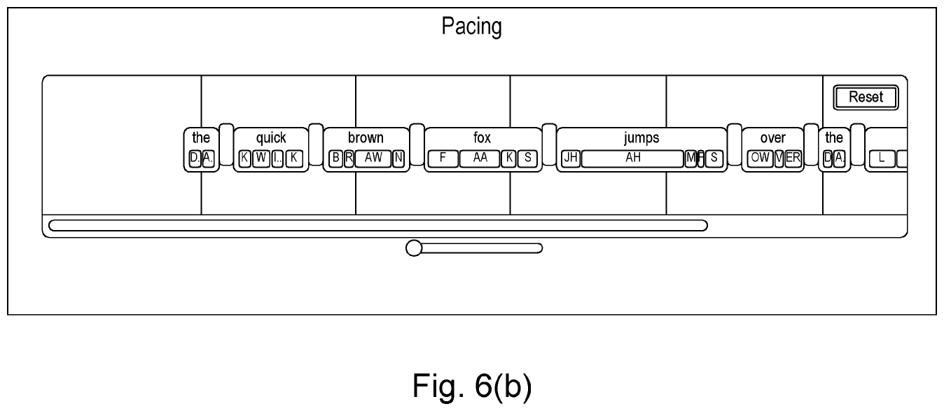

FIG. 6 (a) shows the modification of a pitch track by a user. The pitch track show the variation of a pitch (in Hz) against the number of decoder steps (num_decoder_timesteps) or mel frames. The dots (•) are the result of the analysis in S105-1. The dashed line (- -) shows the modified pitch trace after modification by the user in S105-3. The dashed line represents the control feature vector of S105-5 of FIG. 5. Although FIG. 6 (a) shows a control feature vector that corresponds to the pitch attribute, it will be understood that different properties could be extracted instead, or in addition. For example, the attribute of ‘intensity’ could be used instead, or in addition.

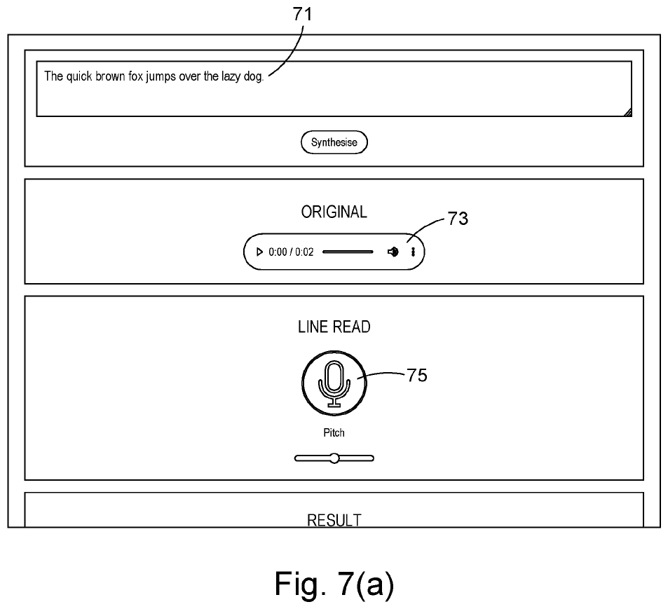

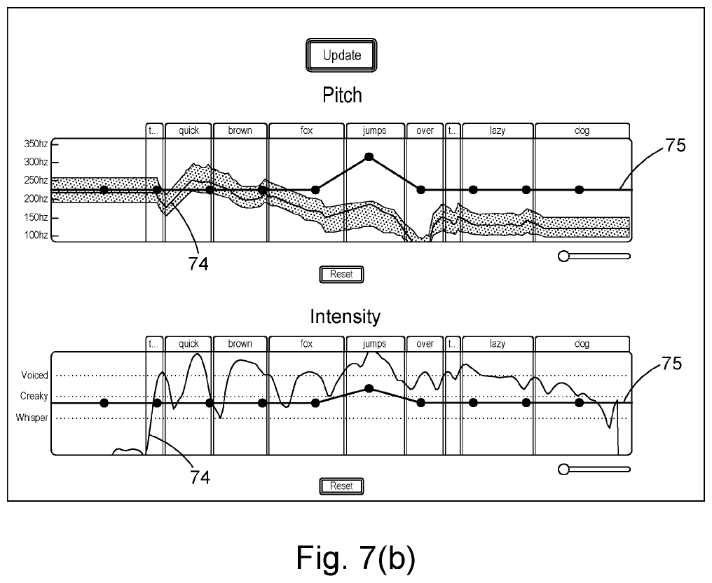

The modified pitch trace, corresponding to the feature vector, may be modified by way of the user editing the value of each element in the pitch trace vector (represented by dots •). Alternatively, the feature vector may be modified using a user interface (UI) and this is described further below in relation to FIG. 7. Both methods of modifying the pitch trace provide fine-grained control in the sense that specific frames at the output of the decoder may be modified.

FIG. 6 (b) is an example of the modification of the timing of a speech signal by way of a user interface. The modification of timing is obtained differently from the control and synthesis feature vectors described above. How it is obtained will be described further below in relation to FIG. 8.

The timing of the phonemes is provided to the user, e.g. the start and end time of each phoneme. The user then modifies these timings using a slider to generate timing parameters. The timing parameters relate to the timing of the phonemes in the text signal and inputted in the TTS system. The modified timings are then used to up/down sample with interpolation the alignment matrix along the time axis.

First the phoneme times are translated to decoder steps. (e.g. each decoder step corresponds to a fixed forward movement in time, so the reverse calculation is possible going from time to the decoder step number). For example, if the phoneme started at decoder step 10 and finished at decoder step 20 for the original timing, and for the modified timing the phoneme starts at decoder step 10 and finishes at decoder step 30, then upsampling by a factor of 2 with interpolation is applied to that part of the alignment matrix.

The controllable model is forced to use this new modified attention matrix. So if in the attention matrix at decoder step 10, a first model attends to phoneme 5, then this is forced to be true in the controllable model. How the attention matrix of the first model is used in the controllable will be described further below in relation to FIG. 8 (a).

FIG. 7 (a) shows a user interface (UI) for modifying properties of a speech signal. The UI comprises a text input 71 fora user to provide an input text signal. The UI also includes a user button that provides an unmodified speech signal (the provision of an unmodified speech signal to the user corresponds to S03 of FIG. 1).

The UI also shows a ‘line read’feature 75. The ‘line read’feature 75 is a means of controlling the generated signal using voice. The user speaks a line of text, which corresponds to a spoken speech signal. With reference to FIG. 4, the spoken speech signal is obtained after a synthesised speech signal is obtained in step S103. The spoken speech signal is analysed and a control feature vector is extracted. The control feature vector is then passed as an input to the model (similar to S107 of FIG. 4).

In an example, the analysis of the spoken speech signal relates to the pitch of the spoken speech signal. The pitch vector may be extracted steps similar to that described above.

The steps are the following:
Compute the pitch vector of the signal. Optionally, silence is removed from the recorded audio of the spoken speech signal either before or after computing the pitch vector.
Squish (compress) or stretch the pitch vector from the spoken speech signal to match the length of the synthesised speech signal obtained in step S103.

FIG. 7 (b) shows a user interface (UI) for modifying the pitch and intensity of a speech signal. A text signal is obtained using the interface of FIG. 7 (a) above. An analysis of the signal 74 is provided in the UI. The analysis corresponds to S04 of FIG. 1 or S14 of FIG. 2. In FIG. 7 (b) the analysis refers to pitch and intensity; however, the analysis may also refer to any of the properties described in relation to FIG. 5.

As described in FIG. 6, the pitch track or the intensity track each correspond to a control feature vector. To make the vectors easier to edit, a subset of the pitch or intensity values are chosen to be editable using a slider. The sliders are shown as dots on the traces 75 in FIG. 7 (b). The changes to the values between these directly editable values are determined using linear interpolation with respect to the values that are editable before and after it. In the case of pitch, to keep the changes within a “safe” range, i.e. a range which is likely to avoid low quality or bad speech signal output, the data used to train the model is analysed for changes in pitch. The frequency axis is binned into a sufficiently large number of bins, e.g. integer values, from the minimum to the maximum pitch of the dataset. For each of these bins the changes in pitch are analysed by finding all the examples of that pitch in all the pitch tracks, and looking at the change in pitch+60 or −60 samples either side. Modelling this set of values we arrive at a standard deviation for each bin, and therefore a set of pitch dependent safe frequency ranges over which the pitch may be varied in the UI. This pitch range can be seen in 74 as a shaded area around the white line (pitch track). The sensitivity of the sliders on the traces 75 is automatically adjusted so that the pitch will not go out of this safe range when dragged to the top or bottom of the UI. Between the sliders, linear interpolation is used to determine the change in pitch, taking into account the slider before and after. For example, if x is the initial pitch value, d1 is the distance to slider 1, d2 is the distance to slider 2 and the new pitch value is y then y=(d2/(d1+d2))*(slider_1*sensitivity_1)+(d1/(d1+d2))*(slider 2*sensitivity_2)+x. The safe range may be used to clip the new value y and keep it in the safe range for example.

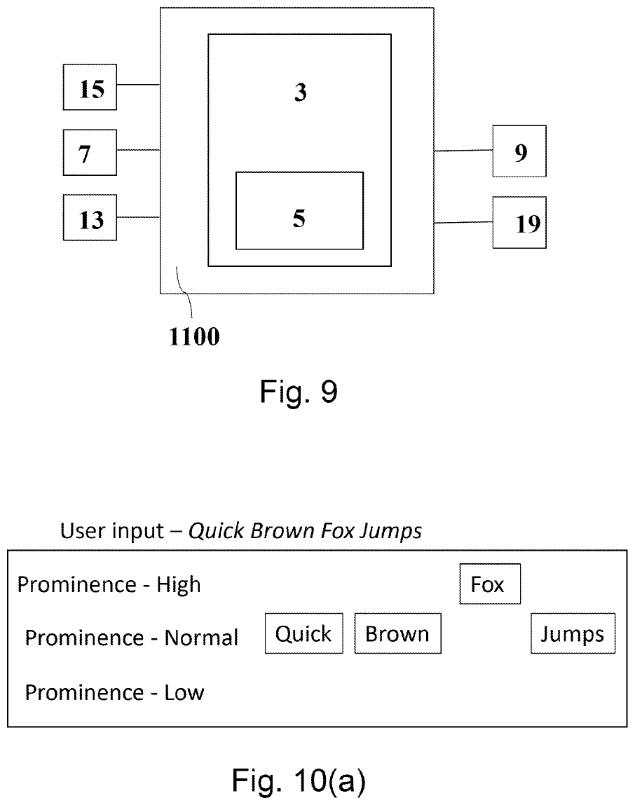

As will be described in relation to FIG. 9, some of the processes of the system may be carried out on a user terminal, while others are carried out on a separate TTS system, which may be based on a server.

The steps carried out on the user terminal are the receipt of the analysis (e.g. pitch and intensity tracks and alignments for the synthesised audio), the modification of these pitch, intensity and alignments, and the sending off to the TTS system and the receipt of the modified speech audio once this has been rendered by the TTS system. The rest is carried out on the TTS system, i.e. the synthesis of the first audio example given the text received from the users terminal, the generation of the pitch, intensity and alignments and the delivery of all those to the user. The receipt of the modified pitch, intensity and alignments and the synthesis with the controllable model that produces the modified audio and the delivery of the modified audio to the user, are performed on the TTS system.

FIG. 8 (a) shows a shows a schematic illustration of a TTS system comprising a controllable speech model. The TTS system comprises two stages: stage 1 and stage 2, as shown in the figure. In stage 1, a first speech model 81 is used. The first speech model has an architecture as described in relation to FIG. 3, for example. In stage 2 a second speech model 89, also referred to as a controllable model, is used. The controllable model has an architecture similar to that described in FIG. 3 except that additional inputs are provided at the encoder, attention and decoder modules.

In the diagram, boxes with a dashed (- -) outline indicates that the values are identical, e.g. the text signal 80 is the same in both stage 1 and stage 2. Boxes with a dash-dot (- · -) outline indicates points at which user manipulation occurs.

In Stage 1, a text signal is inputted into a first model 81 configured to convert an input text signal 80 into a speech signal 85. The first model corresponds to a sequence-to sequence model as described in relation to FIG. 3 (a) to 3 (c). In stage 1, the text signal 80, the attention/alignment matrix 87, and the speech signal 85 is made available for stage 2.

In stage 2, the speech signal 85 is analysed. The analysis is similar to that described in relation to FIG. 5. In stage 2 as shown, pitch and intensity properties are derived and provided to the user. The user controls or modifies those properties as described above. The modified pitch and intensity properties take the form of separate control feature vectors, as described above. In addition to pitch and intensity, the properties of formants and harmonicity are also derived from the speech signal 85. These properties are unmodified and form separate synthesis feature vectors. The properties that are unmodified by the user are used to improve the quality of the speech signal generated in stage 2. As described in relation to FIG. 5, which properties are derived and/or modified or not may be varied.

In addition to the speech signal 85, the attention/alignment matrix 87 is available in stage 2. The attention/alignment matrix 87 is used to (i) control the timing of the modified speech signal, and (ii) to derive a ‘Phoneme Timings’ vector (also referred to as a timing vector), which is then used to synthesise the modified speech signal.

The attention matrix 87 relates to the timing of the speech signal. The attention matrix is a num_encoder_steps×num_decoder_timesteps matrix. “num_decoder_timesteps” corresponds to how many frames the resulting audio has, as described above. “num_encoder_steps” corresponds to how many input phonemes the input text has. The elements of the matrix correspond to which phoneme (encoder output) the decoder is attending to at each step of the decoder. From the values, the first and last decoder step (time) that the decoder is attending to a given phoneme can be determined. The start and end times are editable by a user. The user may modify the alignment matrix as described in relation to FIG. 6 (b), for example. The edited start and end times are used to stretch or shrink the attention using interpolation.

The second speech model 89 is then configured to use the modified attention matrix derived from the first speech model and modified by the user. This enables control of the timings of the modified speech signal 91 generated by the second speech model.

The attention matrix is also used to derive a ‘phoneme timings’ vector. The phoneme timings vector has four values: start time, end time, duration and difference of time with the previous phone normalized by mean phone duration. The function of the phoneme timings vector is to synthesise the modified speech signal with high quality and accuracy. The phoneme timings vector has a dimension of 4×num_encoder_steps. The phoneme timings vector is concatenated to the encoder output of the controllable model.

The feature vectors corresponding to the formants, harmonicity, modified pitch and modified intensity are then concatenated to the decoder input of the controllable speech model (also referred to as the second speech model) 89. The concatenated vector is fed frame-by frame to the decoder autoregression/feedback system. The concatenated vector may be understood as an input to the controllable speech model 89.

Additionally and optionally, as described in relation to FIG. 5, the feature vectors may be modified by a pre-net (not shown) before being concatenated. The pre-net is trained together with the controllable model.

To generate a modified speech signal 91 in stage 2, the text signal 80 and the speech signal 85 generated in the first stage are provided as input to the controllable model 89.

The speech audio 85 is passed through a global style tokens (GST) encoder that generates embeddings that are then fed into the encoder of the controllable model 89. The GST takes as input a mel (the mel is derivable from the speech signal 85) which is passed through a stack of convolutional layers followed by a recurrent GRU network. In an example, the mel spectrogram is passed to a stack of six 2-D convolutional layers with 3×3 kernel, 2×2 stride batch normalization and ReLU activation function, and then passed to a recurrent GRU network. The GST outputs embeddings are concatenated with the text embedding of the encoder in the controller model.

FIG. 8 (b) shows a shows a schematic illustration of the training of a TTS system of FIG. 8 (a). The first model is trained in advance, for example using a method such as that described in relation to FIG. 3. The first model may be a single speaker or a multi-speaker model. Using the pre-trained first model, in stage 1, training data for the controllable model is generated by inputting a training text signal 80-b and generating a training speech signal 85-b. When the controllable model is configured as a single speaker model, the training speech signal 85-b is synthesised for a single speaker. When the controllable mode is configured for multiple speaker model, the training speech signal 85-b is synthesised for a multi-speaker model. In addition, mels 85-c corresponding to the speech signal 85-b and attention/alignment matrices 87-b are generated for training. Boxes shown in dash-dash (- -) in stage 1 correspond to components of the training dataset generated in stage 1, and used for training the controllable model in stage 2.

Once the datasets of text, audio, attention/alignment and speech audio have been obtained, the controllable model 89-b is trained to reproduce the mel spectrograms given the inputs that are derived from the speech audio 80-b, alignment/attention and text, as shown in stage 2 of FIG. 8 (b). In more detail, the speech audio 85-b is analysed to derive training feature vectors based on the properties of pitch, intensity, formants and harmonicity. These feature vectors are concatenated at the decoder of the controllable model. Optionally, when one or more of the feature vectors are passed through a pre-net (not shown) before being concatenated at the decoder of the controllable model 89-b, the parameters of the pre-net are also determined during the training of the controllable model, using the same training loss. Although FIG. 8 (b) shows feature vectors derived from pitch, intensity, formants, and harmonicity, it will be understood that only some of those properties may be used to derive training feature vectors that are then fed at the decoder.

The attention/alignment matrix 87-b from stage 1 is used to derive a phoneme timings vector, which is fed into the encoder of the controllable model being trained 89-b. The controllable model 89-b is configured to use the attention matrix 87-b passed from stage 1.

Other inputs for training comprise the training text signal 80-b, which is inputted at the encoder of the controllable model, and the training speech signal 85-b, which is converted to embeddings using a GST encoder and also fed to the encoder. The parameters of the GST encoder are also trained together with the parameters of the controllable model 89-b (that is, using the same training loss).

The training loss is obtained by comparing mel spectrograms output by the decoder and of the controllable model 89-b with mels 85-c generated in stage 1. The training loss is computed using a mean squared error, for example.

Alternatively, in the TTS system of FIGS. 8 (a) and 8 (b), a duration predictor (also referred to as a duration prediction network) is used to link the encoder and the decoder network, instead of the attention module. The duration prediction network enables non-autoregressive architectures to be used at the decoder end. The duration prediction network enables mapping the N phoneme length output onto an M length mel spectrogram output (where N<M) in the non-autoregressive case. This is an alternative intermediate architecture and makes it possible for, e.g. Transformer or Convolutional networks to be used as decoder networks.

The duration prediction may comprise a series of 1 D convolution layers with batch normalisation e.g. 5. Each convolution layer may comprise a 5×1 kernel. The training of the duration prediction network will be described below.

The duration prediction network receives N phoneme length vector as input and outputs an N phoneme length vector which contains the duration of each phoneme in terms of the number of mel frames each phoneme corresponds to. The output of the duration prediction network is referred to as a duration vector. This duration vector can then be used to expand the output of encoder network. E.g. if the output of the duration prediction network is [2,2,4,5] and the output of the encoder network is a series of vectors [v1,v2,v3,v4] then the encoder output is enlarged to [v1,v1,v2,v2,v3,v3,v3,v3,v4,v4,v4,v4,v4], where each vector output is repeated according to the output of its corresponding predicted duration. This vector is now at the same length as the number of mel frames. A decoder may then be used, either auto-regressive or non-auto-regressive to convert this series to a series of mel frames.

To train the duration prediction network, the duration of all phonemes in a text audio pair dataset is obtained. This can be done using a standard TTS model with attention. From the standard TTS model trained on the audio text pair dataset, the ground truth aligned attentions may be taken, i.e. the attentions produced during the training of the attention based TTS model. From the attention matrices obtained for each text < > audio pair, the durations of each phoneme may be obtained by taking the argmax along the encoder dimension which returns the encoder output the model is attending to at each step of the decoder. By counting how many times each encoder output is attended the phoneme duration is obtained. The durations of the phonemes form a duration vector. The final output vector of the duration predictor is compared with the duration vector obtained above and a mean squared error loss is computed. The weights of the duration prediction network are then updated via back propagation.

Similar to the attention/alignment 87 of FIG. 8 (a), the output of the duration predictor of stage 1 is available in stage 2. The output of the duration predictor is used to (i) control the timing of the modified speech signal, and (ii) to derive the ‘Phoneme Timings’ vector (also referred to as a timing vector), which is then used to synthesise the modified speech signal.

To control the timing of the modified speech signal, the duration vector output by the duration predictor is modified so that the phonemes' durations are increased or decreased according to the users input. So, rather than warping the alignment matrix using interpolation, the duration vector values are increased and decreased. This modified duration vector can then be used to calculate the timing vector as above.

To derive the phoneme timings vector, the durations of the phonemes from the duration vector are used to obtain the start time, end time, duration and difference of time with the previous phone normalized by mean phone duration that make up the phoneme timings vector. For example, the start time of a phoneme is the sum of all durations prior to that phoneme (converted to time in the same way that decoder steps are converted to time), etc . . . .

The attention modules in both stages may each be replaced by a duration predictor, or it is also possible to replace only the attention module in the second stage by a duration predictor (and retain the attention module in the first stage). The latter is possible because the phoneme durations (i.e. a duration vector) can be extracted from the attention matrix, as described in relation to the training of the duration predictor.

FIG. 9 shows a schematic illustration of a system for modifying a speech signal according to an embodiment.

The TTS system 1100 comprises a processor 3 and a computer program 5 stored in a non-volatile memory. The TTS system 1100 takes as input a text input 7. The text input 7 may be a text file and/or information in the form of text.

Alternatively or optionally, the TTS system takes as input a spoken speech file 13. The spoken speech input 13 may be a voice recording provided by a user.

Additionally and optionally, the TTS system takes as input control parameters 15. The control parameters 15 may be data from which instructions for running the computer program 5 are derived.

The computer program 5 stored in the non-volatile memory can be accessed by the processor 3 so that the processor 3 executes the computer program 5. The processor 3 may comprise logic circuitry that responds to and processes the computer program instructions. The TTS system 1100 provides as output a speech output 9. The speech output 9 may be an audio file of the synthesised speech and/or information that enables generation of speech.

Additionally and optionally, the TTS system provides as output an analysis 19.

The text input 7 may be obtained from an external storage medium, a communication network or from hardware such as a keyboard or other user input device (not shown).

The spoken speech input 13 may be obtained from an external storage medium, a communication network or from hardware such as a microphone or other user input device (not shown). The output 9 may be provided to an external storage medium, a communication network, or to hardware such as a loudspeaker (not shown) or a display. The output analysis 19 may be data that is displayed on a display means (not shown).

In an example, the TTS system 1100 may be implemented on a cloud computing system, which transmits and receives data. Although a single processor 3 is shown in FIG. 9, the system may comprise two or more remotely located processors configured to perform different parts of the processing and transmit data between them.

Additionally and optionally, the text input 7, the output 9, the analysis 19 (when present), the spoken speech input 13, when present, or the control parameters 15, when present, are provided on a user terminal. The user terminal may be a personal computer or portable device (e.g. mobile phone, tablet or laptop) that is separate from the TTS system 1100.

In a further embodiment, a method is provided for modifying a synthesised speech output to vary how the output emphasizes or varies the prominence of words or certain parts of the sentence.

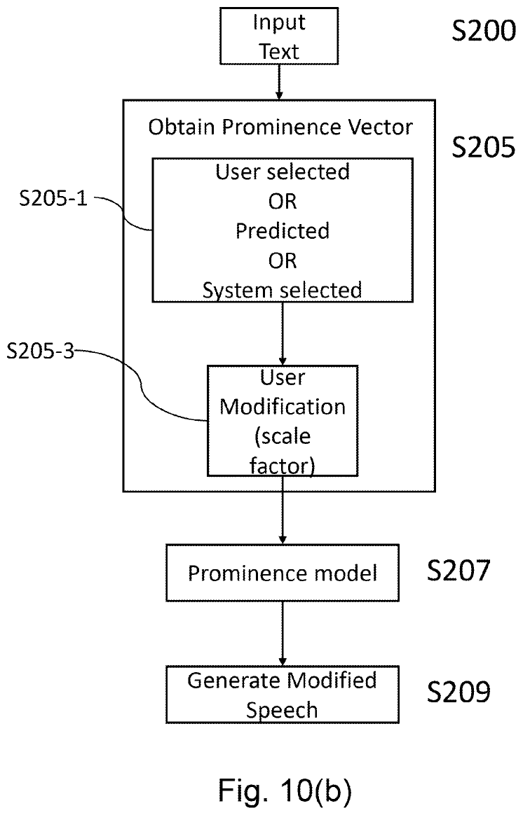

FIG. 10(a) is a schematic showing an example interface for varying the prominence. Here, the user inputs text and can either indicate to the interface where the prominence should fall in the sentence or the user can await a synthesised output of the speech and then indicate how to vary the prominence. For example, if the user enters the words “quick brown fox jumps”, the user can indicate whether each word needs to be output with a high, normal or low prominence. It will be appreciated that this is an example interface and it is possible to have greater or fewer levels of prominence and other graphical methods could be used to allow the user to select the desired prominence of a word or the direct the emphasis in the text to the vicinity of words with a high prominence.

FIG. 10(b) shows a flowchart for varying the prominence.

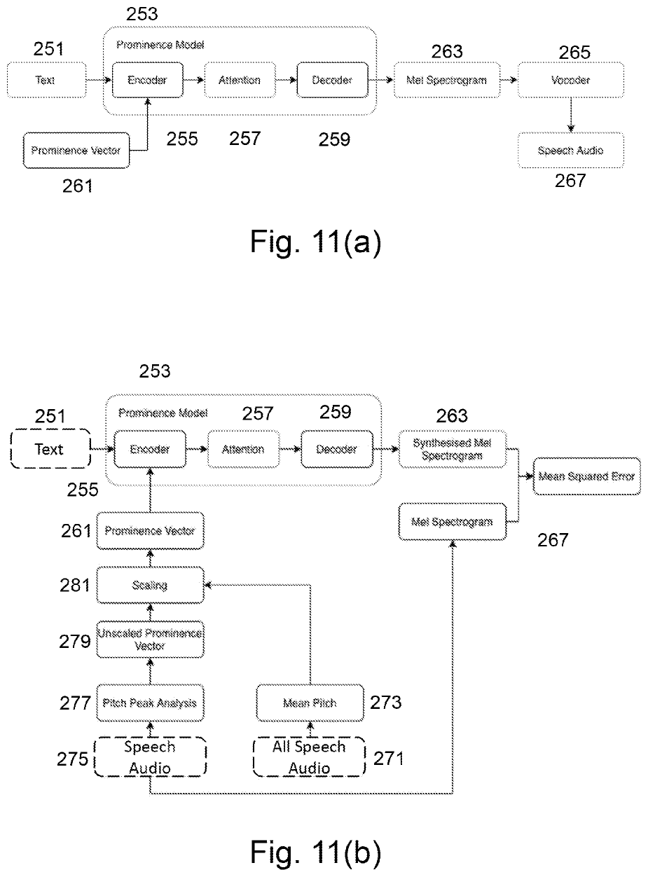

In step S200, the user inputs input text. For example “the quick brown fox jumps over the lazy dog”. In step S205, a prominence vector is obtained for the input text. The prominence vector is a vector where each phoneme of the input text is assigned to a pitch. How this is done will be described with reference to FIGS. 11(a) and (b). Once prominence vector has been derived, the user can modify the prominence vector to change the emphasis in the input text. In an embodiment, the user may be presented with a representation of the text and the user can highlight certain words in that representation in order to indicate that they should be more prominent. Alternatively, the user may be presented with a numerical or graphical representation of the sentence and the user may increase or decrease the numbers assigned to certain words or move certain features of the graph to indicate which words should be emphasised as suggested in FIG. 10(a).

Once the user has modified the prominence vector, the prominence vector is applied to the prominence model in step S207 which is then used to output modified speech in step S209.

FIG. 11(a) shows an example of the prominence model that can be used in step S207.

The prominence model 253 is of the encoder 255 decoder 259 type described with reference to FIG. 3 with the output of the encoder 255 is subjected to attention 257. The text is input into the encoder 255. In addition, the prominence vector 261 is also input into the encoder. The prominence vector has the length of the number of time steps of the encoder and reflects the relative prominence of parts of the input text. Prior to inputting the prominence vector, the prominence vector is modified by 2 linear layers or “prenet”. These convolutional layers may have a 5×1 kernel size, for example.

The vector is concatenated to the encoder outputs. The prominence vector is therefore subject to selection by the weights of the alignment matrix, so if the decoder attends entirely to the first encoder output, it also “sees” only the first element of the prominence vector.

The output of the decoder 259 is a sequence of mel spectrograms 263 which are then passed through vocoder 265 to produce modified output speech 267.

To understand the prominence vector, the training of the system will now be described with reference to FIG. 11(b). To avoid unnecessary repetition, like reference numerals will be used to denote like features from FIG. 11(a).

For the prominence model a dataset of text audio pairs is obtained for a single speaker (or multiple speakers if training a multi-speaker model). For each audio example the pitch track is obtained 275 and the average pitch is obtained for each phoneme in the sentence in 277, producing a n phoneme length vector (n_encoder outputs) in 279.

There are many methods for obtaining an association between pitch and phonemes in 277. For example, it is possible to train a normal synthesis model and use the alignment matrix from in the attention network produced during training to determine at which time each phoneme starts and ends. It is also possible to use a “forced aligner”.

The average pitch is then calculated for each phoneme by averaging the pitch between the start and end time of each phoneme.

Once the pitch has been obtained for each phoneme, an n_encoder steps vector is produced where each step corresponds to the average pitch for the phoneme in 279.

This vector can then be simplified or “coarse grained” by binning/scaling/grouping the pitch values into N bins or groups according to pitch/frequency in 281. In an example, N is three which provides integer values {0, 1, 2}. These bins may be obtained by calculating the min and max for the entire dataset in 271 and 273 and splitting that range into three equally sized bins. Using these pitch/frequency bins the average phoneme pitch vector is turned into an integer vector containing the values 0 (lowest frequency bin) to 2 (highest frequency bin).

Once the prominence vector is obtained from the training data, the model is trained as usual, feeding in the text and the prominence vector and learning to produce the Mel spectrogram of the audio by back-propagating the mean squared error loss between the synthesised Mel-spectrogram and the real Mel-spectrogram.

Returning now to the synthesis of FIG. 11(b), the prominence vector selected by the user is scaled to have a value of 0, 1 or 2 from the interface which represented the 0, 1 or 2 values explained in the training. However, it should be noted that even if the training just trains values 0, 1, 2, it is possible in the synthesis to award higher values, e.g. 50 and for this still to work. This enables the user to synthesise sentences with degrees of emphasis/pitch/expressivity beyond what is found in the training set, as the model learns to generalise from the smaller set of values.

In an embodiment, at synthesis time, there are many possible options for obtaining prominence vectors. For example, the user can choose from preset prominence vectors. Alternatively, the system might predict a prominence vector for a given input text, for example using a different model for predicting the emphasis of the sentence. In a further embodiment, the system samples a preset prominence vector e.g. prominence vectors from the training data and the user then chooses a scale factor. The sampling can be done using the training data, though other datasets could be used. One method is to take the input text and get the number of phonemes, then find all prominence vectors in the training set that are the same length as required for this number of phonemes. Then either sample randomly from that set or pick the prominence vector that is most common.

For predicting the prominence vector, it is possible to train a model that takes in text and outputs a prominence vector as described above. This would be trained using prominence vectors derived from a datasets of text-audio pairs, where all the prominence vectors for that datasets are calculated as described above. In an embodiment, a mean squared error loss is used to train the model. The same dataset as the prominence model was trained on could be used to train a model for predicting the prominence model, alternatively it is possible to transfer the prominence vectors of one actor used to produce a training set for the synthesis model onto another.

The above model allows an overall style to be selected for a line of text by emphasising a word which has been selected to be output with increased prominence and the surrounding words. The ‘Prominence vector’ can be viewed as a style vector that the model interprets as, ‘Say this line with emphasis’.

Alternatively, in the TTS system of FIGS. 11 (a) and 11 (b), a duration predictor (also referred to as a duration prediction network) is used to link the encoder and the decoder network, instead of the attention module. The configuration and training of the duration predictor is as described in relation to FIGS. 8 (a) and 8 (b).

In a further embodiment, a method is provided for modifying a synthesised speech output to vary the intonation of a synthesised output of text. Varying the intonation of a sentence allows the sentence to be output with different inflections. For example, the same text can be synthesised as a question or a statement dependent on the intonation of the synthesised speech.

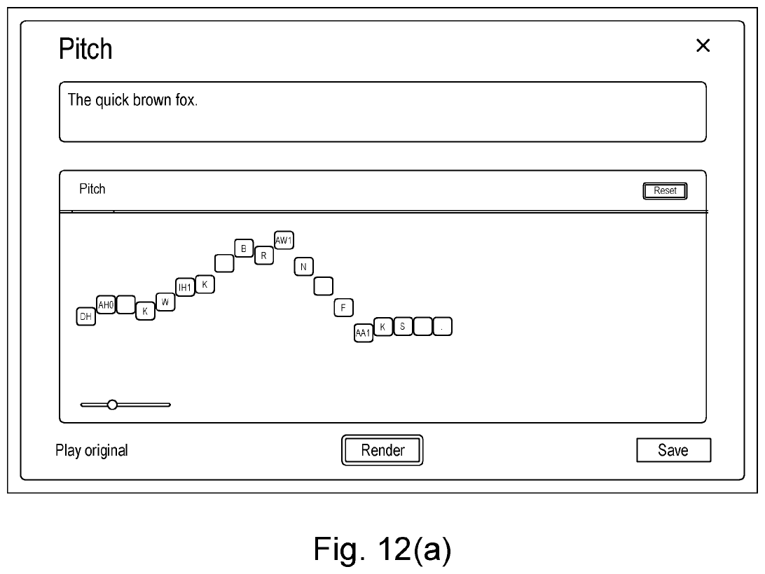

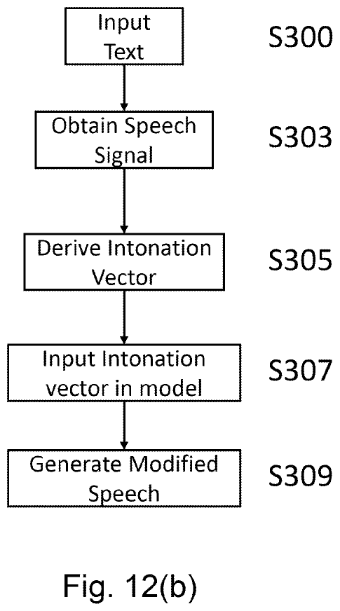

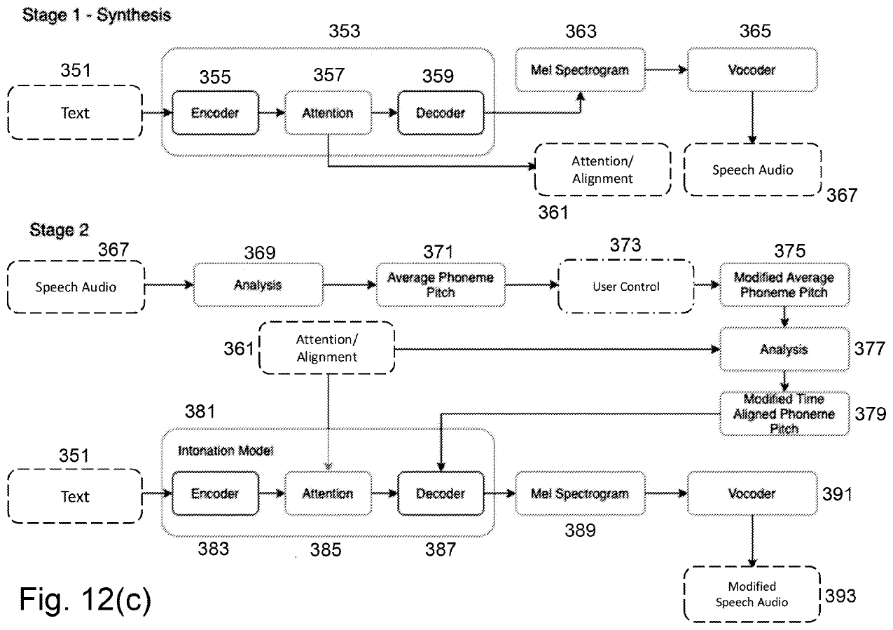

FIG. 12(a) shows an example of a possible interface that can be used for varying the intonation of a text input. The interface comprises a graphical output of the individual phonemes of a text input in time order along the x axis against frequency (pitch) on the y axis. The user has an interface which allows them to raise or lower the phonemes pitch to vary the intonation of the sentence.

In the embodiments described below the synthesised speech is output using the synthesis system comprising an encoder/decoder framework discussed with reference to FIG. 3. The input to the encoder is taken from the input text which is split into phonemes to form a sequence of phonemes. The sequence of phonemes is sometimes referred to as a sequence of encoder timesteps. The output from the decoder will be a sequence of Mel frames representing the synthesised speech, the sequence of Mel frames will also be referred to as a sequence of decoder timesteps.

Two possible arrangements for varying the intonation will be described below. In the first arrangement, there is a two-stage method for producing modified synthesised speech, a first stage where synthesised speech is determined from input text and a second stage where the synthesised speech or signals derived from the synthesised speech are modified and inputted into a second model, along with the input text to output the modified speech. In the second arrangement, the input text is provided directly to a model and the user selects parameters to also input into the model to output and modify the synthesised speech.

The first arrangement will be described with reference to FIG. 12(b). First, the user inputs the text in step S300 to be output by a speech synthesis system. In step 305, synthesised speech is obtained from said input text.

FIG. 12(c) shows a diagram of the first and second stages, the text input from step S300 of FIG. 12(b) is directed as text input 351 of FIG. 12(c) into the speech synthesis model 353. The speech synthesis model 353 comprises an encoder 355 and a decoder 359 linked by an attention network 357. The speech synthesis model 353 is described in more detail with reference to FIG. 3.

The input text 351, is input into encoder 355. The encoder 355 is of the RNN type where the input text is fed as a sequence of phonemes, phoneme by phoneme into the encoder 355 such that each phoneme is fed as a new state into the encoder in each encoder timestep. The sequence is mapped to a hidden space which is then decoded back into a sequence of decoder timesteps by the decoder 359. An attention network 357 operates on the hidden space prior to decoding, the attention network is described with reference to FIG. 3. In response to input speech, the attention network produces an alignment matrix 361 which is an n_encoder×n_decoder steps matrix. The values inside the alignment matrix correspond to which phoneme the decoder is attending to at each step. This is then fed into the decoder to allow the decoder to weight the inputs from the encoder dependent on the alignment matrix 361.

The output from the decoder 361 is a sequence of Mel Spectrograms 363 which are then converted by the vocoder 365 into speech audio 367.

This speech audio 367 is the speech signal that is obtained in S303 of FIG. 12(b)

In step S305, intonation vector is then obtained for the input text in step S300. In an embodiment, the intonation vector is derived from a pitch track that is extracted from the synthesised speech 367 derived from the input text.

The intonation vector is a real valued single dimension pitch vector with a length equal to the number of time steps of the decoder output. In an embodiment, the intonation vector is obtained from a real valued pitch vector with the length of phonemes or encoder input steps and this is then sampled to a vector with a length equal to the decoder timesteps.

The intonation vector is derived from the pitch vector which has pitch values for encoder timesteps. This is shown in stage 2 of FIG. 12(c). The audio track is taken from synthesised speech 367. This is then analysed in 369 to obtain the start and end times of each phoneme. In an embodiment, the start and end times of each phoneme can be obtained from the alignments produced in the attention network during synthesis. The average pitch is then calculated for each phoneme by averaging the pitch between the start and end time of each phoneme.

Once the pitch has been obtained for each phoneme, an n_encoder steps vector is produced where each step corresponds to the average pitch for the phoneme in 371.

Once the pitch vector has been derived from the synthesised speech, the user can modify the vector by the user control 373. This allows the user to increased and/or decrease the pitch of one or more of the phonemes. Referring back to the interface shown in FIG. 12(a), the interface shows the encoder time step pitch vector and the interface allow it is possible to move with a mouse one or more of the phonemes to increase or decrease its pitch to produce the intonation vector.

Additionally and optionally, the pitch for each of the one or more phonemes may by increased or decreased by the user within a predetermined range. The predetermined range may depend on the speaker model.

When the user is then satisfied with the modified intonation vector in 375 this is the obtained intonation vector and it is resampled in 377 to the length of the decoder timesteps using the alignment matrix 361. This process allows a single average pitch for each phoneme for control which is then upsampled to allow it to be used for a detector input.

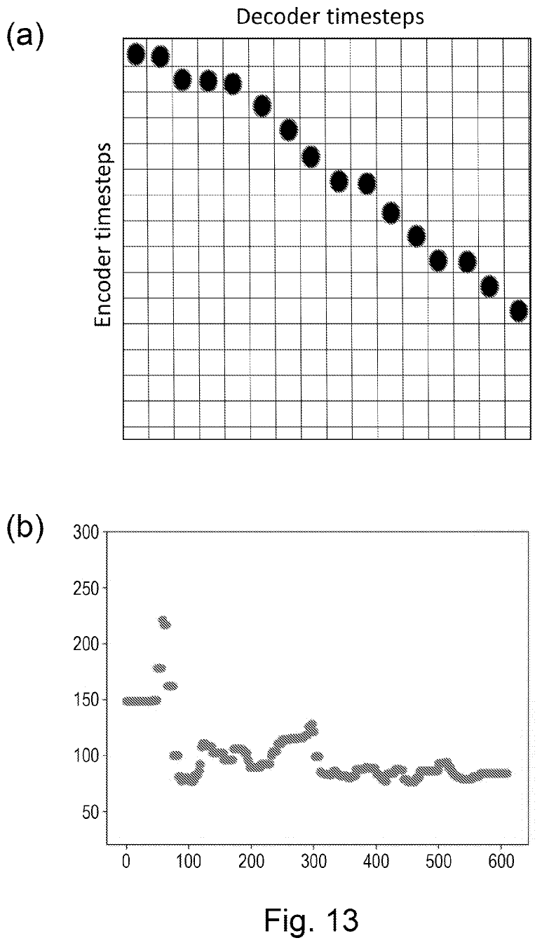

As explained above, the alignment matrix is an n_encoder×n_decoder steps matrix which is produced at synthesis time as shown schematically in FIG. 13(a). FIG. 13(a) is a simplified version where only the highest value for each decoder timestep of the attention is shown as a black dot. In practice, a value will be assigned to each position in the matrix. However, only encoder steps that correspond to decoder steps should have a high value.

The values inside the alignment matrix correspond to which phoneme the decoder is attending to at each step. E.g. if attention[1, 2]=1 then at decoder timestep 2, the decoder was attending to the 1st phoneme. The values are normalised so that the sum attention[0, n]+attention[1, n] . . . +attention[n_encoder, n]=1 (i.e. the sum along the encoder dimension is 1). Starting with an empty feature vector [ ], for each decoder step it is determined which phoneme is attended to the most (i.e. has the largest value in along the encoder axis) and then the average pitch for that phoneme is appended to the feature vector. FIG. 13(b) shows the time aligned phoneme pitch for the intonation vector that has been resampled to the decoder timesteps.

Referring to FIG. 12(b), the intonation vector is then input into an intonation model in step 307 and modified speech is then output in step S309.

FIG. 12(c) shows the intonation model 381 which is very similar to the model 353 of stage 1. The intonation model 381 has an encoder 383 decoder 387 architecture where the encoder 383 and decoder 387 are linked by an attention network 385. However, the intonation model 381 differs in a number of significant ways:
i) The model 381 has been trained using text and synthesised speech as opposed to real speech
ii) The alignment matrix of the attention network 383 is not predicted from the input text, but the alignment matrix is taken from stage 1 and imposed on the output of the encoder of stage 2.
iii) The decoder 387 also receives the intonation vector.

Before the upsampled intonation vector 379 is fed into the decoder 387, it is modified by convolutional layers “prenet” and then fed frame-by-frame to the decoder 387 autoregression/feedback system (here it becomes a model input). This is done by appending each value of the intonation vector to the “decoder input” vector. This decoder input vector is essentially the previous Mel Frame after it's passed through a different prenet.

The above description has used pitch as an example of an intonation vector. However, it is also possible for the intonation vector to be an intensity vector. An intensity track can be derived in the same way as a pitch track and then an intonation intensity vector is obtained from an intensity track in the same way as an intonation pitch vector is derived from a pitch track. Any parameter of the speech can be used as an intonation vector. It is possible for different types of intonation vector, i.e. pitch, intensity to be provided to the model.

In the same way of for model 353, the output of intonation model 381 is a sequence of mel spectrograms 389 which are then passed through vocoder 391 to produce modified output speech 393.

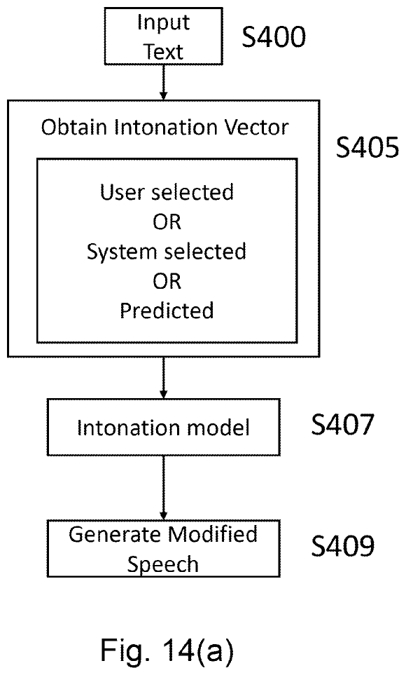

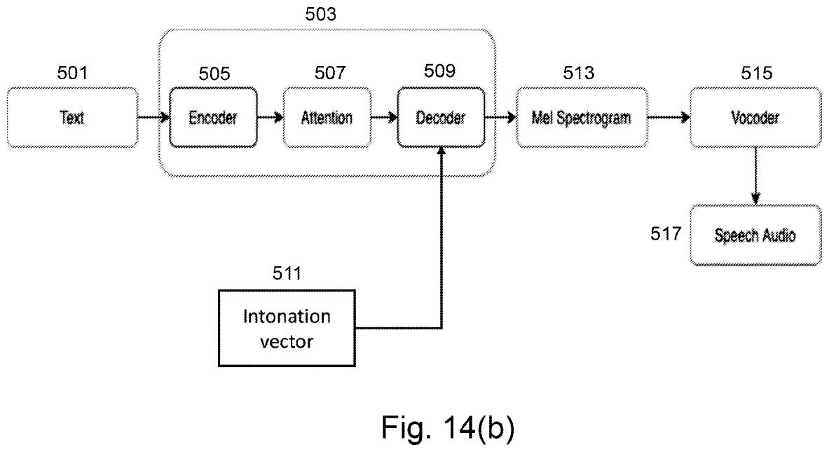

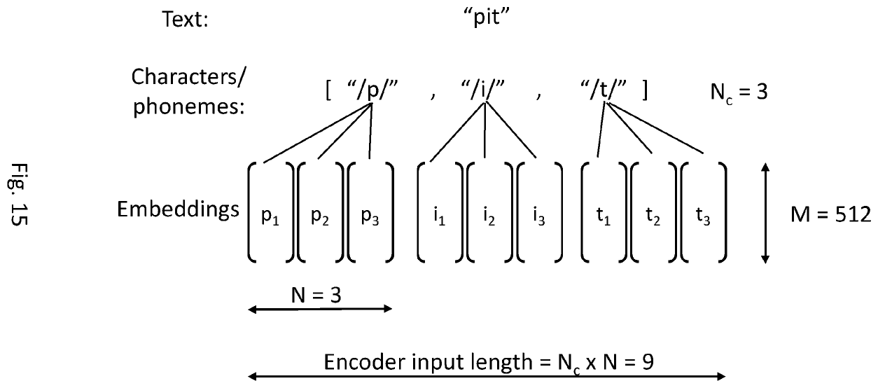

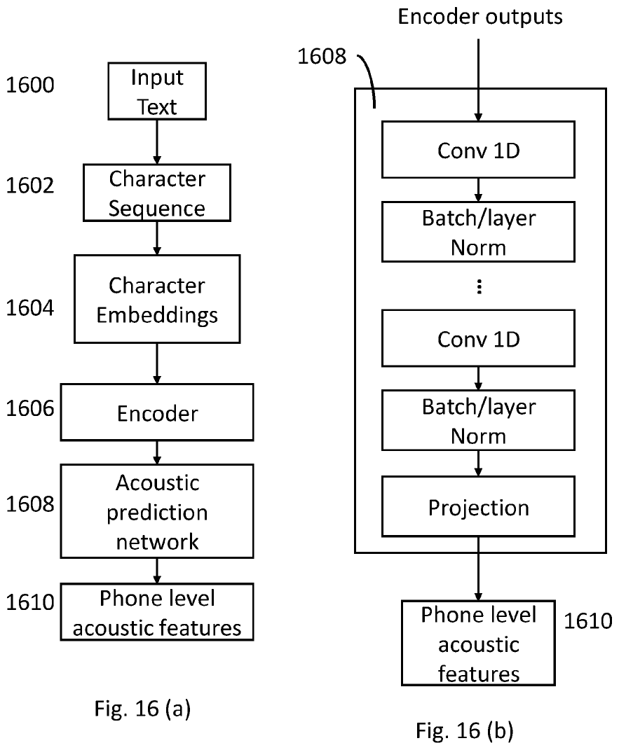

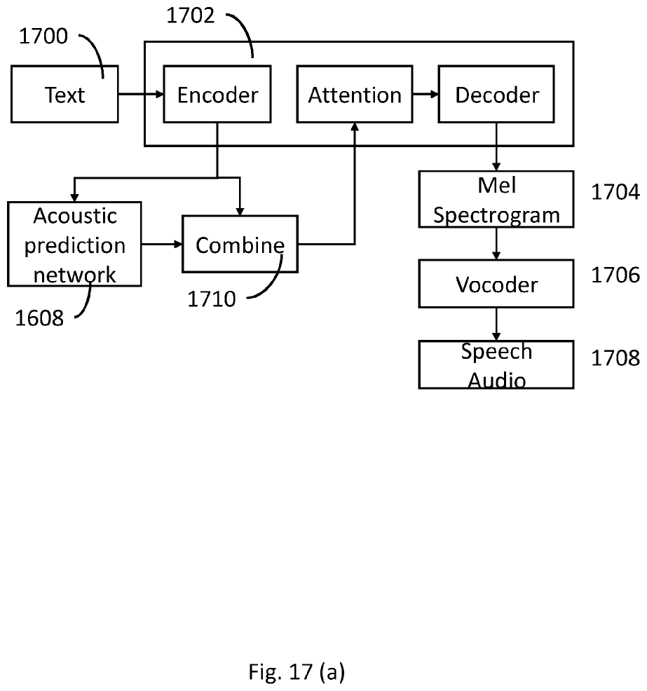

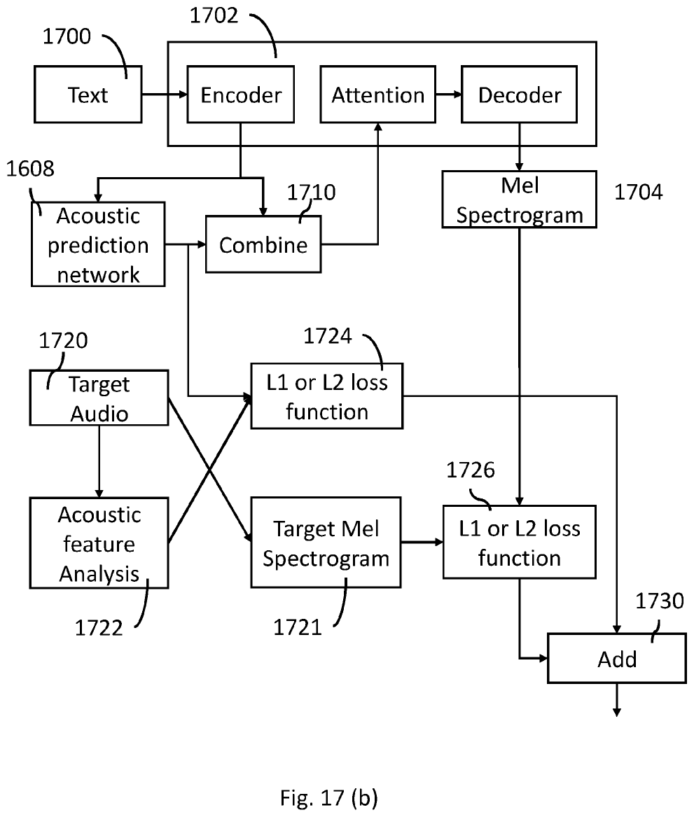

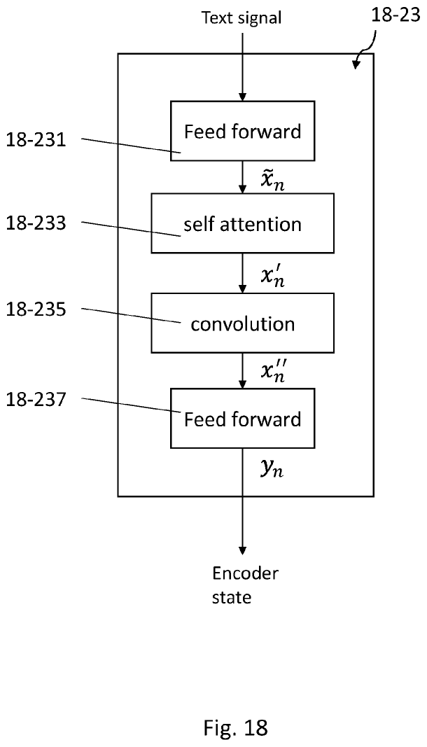

FIG. 14(a) is a flowchart showing the basic steps of the one stage arrangement. As the two-stage arrangement, input text is acquired at step S400. Next, in step S405, the user obtains an intonation vector. The intonation vector may be selected by the system, for example, if the user suggests that he wishes the intonation to indicate a question, the system can set intonation vector whether pitch of the later phonemes on the question is increased.

Referring back to the user interface shown in FIG. 12(a), the user may be provided with phonemes at a particular pitch, for example one that is typical for the selected input text and the user can drag the phonemes to increase or decrease their pitch as required. In such an arrangement, the user will be giving a pitch vector which may have been obtained from historical audio recordings or prior synthesis. In one embodiment, the initial pitch vector is all at the same pitch for the entire sentence and the user can increase or decrease the pitch as required. Once the user has obtained their intonation vector, it is then fed into the intonation model in step S407 and modified speech is generated in step S409.

FIG. 14(b) shows a single-stage synthesis for the modified intonation vector. As before, input text 501 is input into intonation model 503. The intonation model is similar to that described in relation to FIG. 3 and also in FIG. 12(c). The intonation model 503 comprises an encoder which is linked to a decoder 509 fire and attention network 507.

The difference between the intonation model 503 and the model described in the first stage of the synthesis in FIG. 12(b) is that an intonation vector is directly input into the decoder 509.

Prior to being input into the model 503, the intonation vector is upsampled from vector having the length of the number of encoder time steps to one that has a number of decoder time steps. However, in this instance, the full alignment matrix will not be available so the upsampling occurs during synthesis. This is done in the following way. At each step of synthesis a single value of the intonation vector is fed into the decoder. Which value is determined by the argmax of the attention vector from the previous step of synthesis. e.g. The first attention vector is assumed to be the vector (1,0,0,0,0,0 . . . ) (i.e. attending to the first encoder output). The argmax of this vector is 0 (assuming index counting starts at 0), therefore the zeroth (i.e. first) value in the intonation vector is fed into the decoder at this step. Note that argmax(ƒ) is a function that returns the argument or arguments for the function ƒ that returns the maximum value from ƒ.

In this case, if a prenet is used, it is an RNN prenet, which accepts each value at each step of synthesis one by one. (The convolutional prenet requires all values to be present at the start of synthesis as it receives the full upsampled intonation vector as input)

Before the upsampled intonation vector 511 is fed into the decoder 509, it is modified by convolutional layers “prenet” and then fed frame-by-frame to the decoder 509 autoregression/feedback system (here it becomes a model input). For example, the convolutional layers have a 5×1 kernel size. The output of intonation model 503 is a sequence of mel spectrograms 513 which are then passed through vocoder 515 to produce modified output speech 517.

The single stage and two stage intonation models are trained as follows. For the two stage model the synthesis stage is a known speech synthesis model and is trained using datasets of text audio pairs from a single speaker (or multiple speakers if the model is to be trained for multiple speakers). For each original audio sample, the pitch track is analysed and the average pitch is obtained for each phoneme in the sentence, producing a n phoneme length vector (n_encoder outputs). These average phoneme pitches are then upsampled to full time aligned vectors with the same length as the number of decoder steps. In an embodiment, this is done by pre-training a model on the text audio pairs and extracting the alignments that result during the training process. Once the model is trained these alignments show which phoneme is being attended to at each decoder step, using this it is possible to count number of decoder steps each phoneme is attended to and upsample the average pitch vector accordingly.

Then, with the text, original audio, and time aligned average phoneme pitch it is possible to train the intonation model for the single stage model and/or the two-stage model. In an embodiment, the loss function used is a MSE error loss between the exact Mel spectrogram and the predicted spectrogram.

During the training, even though in second stage model, the alignment matrix is supplied (forced) on the model, there is no need for training with the forced alignment. This is because the model will learn alignments very similar to the pre-trained model (since the datasets are the same, the timing and type of phoneme are exactly the same), and will therefore be very similar to the alignments used to produce the intonation vectors.

Alternatively, in the TTS system of FIGS. 12 (c) and 14 (b), a duration predictor (also referred to as a duration prediction network) is used to link the encoder and the decoder network, instead of the attention module. The configuration and training of the duration predictor is as described in relation to FIG. 8 (a) and FIG. 8 (b).

In relation to the two-stage model of FIG. 12 (c), similar to the attention/alignment 361 of FIG. 12 (c), the output of the duration predictor of stage 1 is available in stage 2. The output of the duration predictor of the first stage would be used by the second model, rather than running the second stage duration predictor. This is equivalent to the alignment matrix being taken from stage 1 and imposed on the output of the encoder of stage 2, as for FIG. 12 (c). Here, the second stage network is forced to use the given duration vector. Once the pitch for each phoneme is obtained, the resampling 377 involves repeating the pitch values as prescribed by the duration vector. For example, when the phoneme pitch vector is [100,200,100] and the duration vector is [1, 2, 2] then the resampled pitch vector is [100, 200, 200, 100, 100]. If the duration vector contains floats e.g. [0.9, 1.9, 0.9] the vector may be rounded to the nearest integer e.g. [1, 2, 1].

In relation to the single stage model of FIG. 14 (b), prior to being input into the model 503, the intonation vector is up-sampled from vector having the length of the number of encoder time steps to one that has a number of decoder time steps. Upsampling may be performed during synthesis using the duration vector as described above, instead of using an alignment matrix.

While certain embodiments have been described, these embodiments have been presented by way of example only, and are not intended to limit the scope of the inventions. Indeed the novel methods and apparatus described herein may be embodied in a variety of other forms; furthermore, various omissions, substitutions and changes in the form of methods and apparatus described herein may be made.

FIG. 15 shows a schematic illustration of a representation of a text signal by a sequence of units, where each unit is represented by a plurality of embedding vectors.

In a further embodiment, a text signal may be represented by a sequence of units, wherein each unit is represented by a plurality of embedding vectors.

In an embodiment, an embedding vector is an embedding comprising an M dimensional, vector, where M is whole number. For example, an embedding vector is an embedding comprising a vector having the form 1×M. For example, M may be greater than 1.

The representation of a text signal by a sequence of units, wherein each unit is represented by a plurality of embedding vectors, may be applied to any of the embodiments described herein. For example, the representation may be applied to the TTS system described in relation to FIG. 8 (a) and FIG. 8 (b); the TTS system of FIG. 11 (a) and FIG. 11 (b); the TTS system of FIG. 12 (c) and the TTS system of FIG. 14 (b).

By representing the text signal as a sequence of units, wherein each unit is further represented by a plurality of embedding vectors, the quality of the speech signal may be improved.

A unit may be a character or phoneme, for example.

In an embodiment, a method is provided for modifying a speech signal generated by a text-to-speech synthesiser. The method comprises:
receiving a text signal;
representing the text signal as a sequence of units,
   wherein each unit is further represented by a plurality of embedding vectors;
generating a speech signal from the text signal;
deriving a control feature vector, wherein the control feature vector represents modifications to the speech signal;
inputting the control feature vector in the text-to-speech synthesiser, wherein the text-to-speech synthesiser is configured to generate a modified speech signal using the control feature vector; and
outputting the modified speech signal.

In an embodiment, deriving a control feature vector comprises:
Determining an acoustic feature vector from the received text signal, by way of an acoustic prediction network;
Obtaining a user input, and
Modifying the acoustic feature vector using the user input to obtain the control feature vector.

The method allows a user to synthesise speech from text using a standard speech synthesiser text to speech (TTS) model. The system analyses the speech output and extracts acoustic features which can then be used to control and modify the output. The user can modify the acoustic features via a user interface. A vector, incorporating the modified acoustic features, is then input with the text to be synthesised into a further text to speech system (which will be termed the controllable model) and the controllable model outputs modified speech.

By representing the text signal as a sequence of units, wherein each unit is further represented by a plurality of embedding vectors, the quality of the modified speech signal may be improved and the modifications to the speech signal may be controlled more precisely.

The representation of a unit, such as a phoneme, by a plurality of embedding vectors, may be referred to as sub-phoneme representation. For ease of language, the expression “sub-phoneme representation” may also be used to refer to the representation of another unit, such as a character, by a plurality of embedding vectors.

The controllable model may comprise an encoder module. The encoder module is as described herein.

The encoder module may be configured to take, as an input, a representation of the text signal as a sequence of units, wherein each unit is further represented by a plurality of embedding vectors.

The controllable model may comprise an encoder module, a decoder module, and either an attention module linking the encoder module to the decoder module, or a duration predictor linking the encoder to the decoder module.

The encoder and decoder may be of the RNN type and so provide a sequence to sequence model.

The duration prediction network is as described previously.

FIG. 15 shows a schematic illustration of representing each unit in a sequence of units by a plurality of embedding vectors.

In FIG. 15, a text signal comprises the word “Pit”. The text signal is represented as a sequence of phonemes (or alternatively characters). The text signal “Pit” is represented by a sequence of: [“/p/”, “/i/”, “/t/”]. The number of phonemes or characters is represented by Nc. In this case, Nc=3.

Each phoneme (i.e. each unit) is further represented by a plurality of embedding vectors (embeddings). The number of embedding vectors used to represent each unit is represented by N, where N is >1. Each embedding vector is an M dimensional vector. In FIG. 15, each phoneme is represented by three embedding vectors (N=3). E.g. the phoneme “/p/” is represented by vectors p1, p2 and p3. Vectors p1, p2 and p3 are each M dimensional embedding vectors. Similarly, the phoneme “/i/” is represented by vectors i1, i2 and i3, and the phoneme “/t/” is represented by vectors t1, t2 and t3.

In FIG. 15, M=512. Each phoneme is then represented by a N, M dimensional embedding. Note that an embedding vector may also be referred to as a character embedding or an embedding.

Although M=512 in the example of FIG. 15, M may be any positive integer. For example, M>1.

The representation of the text signal may be fed into an encoder, and the encoder input length is then Nc×N. In FIG. 15, for the text signal “Pit”, Nc=3 and N=3 such that the encoder input length is 9.

Each character from the sequence of characters may be represented by N, M-dimensional character embedding, where M in an embodiment is 512 and N in an embodiment may be 3. In the case where the characters represent phonemes, the previous embodiment where N=3 represents a tri-phone representation of each phoneme. In the example of FIG. 15, the phoneme “/p/” is represented by three character embedding vectors, p1, p2 and p3. The values of these character embeddings are learnt by the network at training time. The character embeddings are learnt as described in relation to FIG. 8 (a) and FIG. 8 (b), for example.

The advantages of the N-Phone representation are that a more fine-grained control over the phonemes duration and sound may be obtained. The quality of the TTS may be improved.

In particular, the quality of the TTS, as measured in terms of a mean opinion score (MOS), in a case where a hard monotonic attention (where only values of 1 or 0 are allowed in the attention matrix/alignment) or in a case where a duration prediction is used may be improved. The N-phone representation allows for smoother transitions between phones.

The representation of a text signal by a sequence of units, wherein each unit is represented by a plurality of embedding vectors may be applied to the TTS system described in relation to FIG. 8 (a) and FIG. 8 (b); the TTS system of FIG. 11 (a) and FIG. 11 (b); the TTS system of FIG. 12 (c) and the TTS system of FIG. 14 (b), for example.

The representation of a text signal by a sequence of units, wherein each unit is represented by a plurality of embedding vectors may be applied to any of the embodiments described herein.

Duration Control

The modification of timing of a speech signal has been described previously in relation to FIG. 6 (b) and FIG. 8 (a).

In the example shown in FIG. 8 (a) and FIG. 8 (b) it is described how the alignment matrix may be modified to control the timings of the modified speech signal generated by the second speech model.

When the text signal is represented by a sequence of Nc units, wherein each unit is represented by a plurality of embedding vectors (N), the attention/alignment matrix 87 may be used to (i) control the timing of the modified speech signal, and (ii) to derive a ‘Phoneme Timings’ vector (also referred to as a timing vector), which is then used to synthesise the modified speech signal in a similar manner to that described in relation to FIG. 6 (a) and FIG. 8 (a), except that the encoder input length is then Nc×N. In other words, “num_encoder_steps” becomes equal to Nc×N. Representing each phoneme or character by more than one character embedding enables control of the duration at the sub-phoneme level by modifying the alignment for that encoder output such that the number of decoder steps for which that encoder output is “attended” is increased/decreased.

In relation to FIG. 8 (a) and FIG. 8 (b), an alternative arrangement where a duration predictor (also referred to as a duration prediction network) is used to link the encoder and the decoder network, instead of the attention module, is also described. This alternative arrangement may also be combined with the representation of a text signal by a sequence of units, wherein each unit is represented by a plurality of embedding vectors.

For the arrangement with the duration predictor, representing each phoneme or character by more than one character embedding also enables control of the duration at the sub-phoneme level. For the duration predictor arrangement, the duration of the encoder output is increased. E.g., as described previously, the duration predictor is used to expand the output of the encoder network. For example, the duration predictor is used to map from [v1,v2,v3]->[v1,v1,v2,v2,v2,v3,v3,v3,v3,v3] using predicted durations d=[2,3,5], where v1 might represent a sub-phone of the phoneme “/v/” and the duration of that sub-phone may be manipulated by altering the value at position 1 in the duration array d.

Alternatively, the length of the full phoneme may be altered, rather than a sub-phone (as sub-phones might be too precise). Suppose an increase in length of the phoneme “/v/” by 10% is desired in the above example (where d=[2,3,5]). The total duration is 2+3+5=10. 10% of 10 is 1, so an increase of the total duration by 1 is desired. Since the durations have to be integers, the duration increase may not be applied evenly (to every sub-phone) in this case, but a sub-phone must be selected for applying the duration. How to select a sub-phone and apply the duration increase may be performed in different ways. Some examples may including random assignment, left-to-right assignment, middle outwards assignment and middle outwards assignment with the constraint that the middlemost phoneme must always have the largest increment.

Examples of how the duration vector d, may be modified to alter the length of the full phoneme are illustrated below. In the below “inc” represents the duration increment to be applied to a phoneme. “inc”=1 represents when a duration increment of 1 is to be applied, “inc”=2 represents when a duration increment of 2, and so on . . . . For each example, it is illustrated how the values v1, v2, v3 in the duration vector d=[v1, v2, v3], could be altered to achieve the desired duration increment (inc).
Left to right assignment

inc=1, [v1+1,v2,v3]

inc=2, [v1+1,v2+1,v3]

inc=3, [v1+1, v2+1, v3+1]

inc=4, [v1+2, v2+1, v3+1]
middle outwards assignment (left first)

inc=1, [v1,v2+1,v3]

inc=2, [v1+1,v2+1,v3]

inc=3, [v1+1, v2+1, v3+1]

inc=4, [v1+1, v2+2, v3+1]
middle outwards assignment (right first)

inc=1, [v1,v2+1,v3]

inc=2, [v1,v2+1,v3+1]

inc=3, [v1+1, v2+1, v3+1]

inc=4, [v1+1, v2+2, v3+1]
middle outwards assignment (left first) with the constraint that the middlemost phoneme must always have the largest increment

inc=1, [v1,v2+1,v3]

inc=2, [v1, v2+2, v3]

inc=3, [v1+1, v2+2, v3]

inc=4, [v1+1, v2+2, v3+1]

Phone/Character or Sub-Phone/Character Level Acoustic Prediction Network

In relation to FIGS. 5 and 8 (a) it is described how attributes such as pitch, intensity, formant, harmonicity may be derived.

In an alternative embodiment, the acoustic features are derived using an acoustic prediction network. The acoustic prediction network may be used to derive features such as pitch, intensity, formant, harmonicity. The acoustic prediction network may also predict attributes such as spectral tilt.

Spectral Tilt

In an embodiment, spectral tilt is obtained as follows. Given a frame of a spectrogram e.g. mel spectrogram, linear regression can be performed to find a line that best fits the values in the frame. In an example, a mel spectrogram of dimension N_f by N_b is provided, where N_f is the number of frames and N_b is the number of frequency bins. For example, N_b=80. The first frame is then a vector of 80 values. Linear regression may be used to find an equation of the form y=mx+c that best fits the 80 values. The spectral tilt is then defined as the slope of this line of best fit, i.e. the value m.

Returning to FIG. 16 (a), FIG. 16 (a) shows a schematic illustration of the prediction of acoustic features using an acoustic prediction network. FIG. 16 (b) shows a schematic illustration of the acoustic prediction network.

In FIG. 16 (a), an input text 1600 is converted to a character sequence 1602, which is further represented by character embeddings 1604. The character embeddings 1604 may correspond to any character embeddings described herein. For example, the character embeddings 1604 may correspond to the representation described in relation to FIG. 15. Alternatively, the character embeddings 1604 may correspond to the character embedding described in relation to FIG. 3 (b).

The character embeddings are then fed to an encoder 1606. Encoder 1606 may correspond to the encoder of any of the TTS systems described herein. The output of the encoder is fed to the acoustic prediction network 1608. The output of acoustic prediction network 1608 is a vector representing acoustic features 1610.

FIG. 16 (b) shows that the encoder outputs are directed to the acoustic prediction network 1608. The acoustic prediction network comprises a series of 1D convolution layers (Conv 1D) with batch normalisation (Batch/layer Norm). For example, there may be a series of five Conv 1D and batch/layer Norm. Each convolution layer may comprise a 5×1 kernel. The final layer is a linear projection (Projection) projecting down to the number of acoustic features being predicted. For example, in the case of a prediction network that predicts two acoustic features (N_af=2) and has an encoder character embedding dimension of 512 (M=512), the final layer projects the N_c by M vectors down to N_c by N_af, where N_c is the number of characters/phones in the character sequence, and N_af is the number of acoustic features predicted by the network.

When the input text 1600 is represented using the sub-phone representation of FIG. 15, N_c is replaced by N_cxN. In other words, for sub-phone representation, the final layer projects the (N_cxN) by M vectors down to (N_cxN) by N_af.

The N_c by N_af vector or the (N_c×N) by N_af may be referred to as an acoustic feature vector. The acoustic feature vector is the vector outputted by the acoustic prediction network. The acoustic feature vector relates to one or more (=N_af) acoustic features. The acoustic feature vector is obtained from a text signal.

The acoustic prediction network 1608 may be trained as described in relation to FIG. 17 (b).

FIG. 17 (a) shows a schematic illustration of the acoustic prediction network together with a TTS system. The TTS system may be any of the TTS system described herein.

The combination of the acoustic prediction network with the TTS system forms an alternative TTS system. The alternative TTS system may be used for generating a speech signal and/or optionally for generating a modified speech signal.

In FIG. 17 (a), a text signal 1700 is provided and directed to a TTS system 1702. The TTS system 1702 may correspond to any of the TTS systems described herein. Although the Figure shows an attention module lining the encoder and decoder modules, it will be understood that, instead, a duration predictor may link the encoder and decoder modules, as described herein. The output of the TTS system is a mel spectrogram 1704, which is fed into a vocoder 1706 to obtain speech audio 1708. The outputting of a mel spectrogram, the vocoder 1706, and the obtaining of speech audio 1708 corresponds to the any of the TTS systems described herein.

In FIG. 17 (a), the output of the encoder of the TTS system 1702 is directed to an acoustic prediction network 1608, and a combine module 1710. Here “Combine” might, for example, represent concatenation, where the N_c by M encoder outputs become N_c by (M+N_af) as the acoustic features are appended along the character embedding dimension. Alternatively it might represent projection and addition, where the N_c by N_af output of the acoustic feature prediction network are projected back using a linear layer to have dimensions N_c by M (the same as the encoder outputs) so that they can be added together. In the projection case another neural network (with the same or similar architecture to any encoder described herein) may be used to process the projected acoustic features before adding to the encoder outputs.

The encoder output, combined 1710 with the acoustic feature vector, is then directed to the Attention module of the TTS system 1702.

Note that N_c may be replaced by (N_c×N) when a sub-phone representation is used.

The purpose of the alternative TTS system is to enable acoustic features to be computed directly from a text signal. From the text signal and the predicted acoustic features, a speech signal may be generated.

Optionally, the acoustic features may be modified by the user, and then used to modify a generated speech signal. For example, the acoustic features may be modified as described in relation to any of the embodiments described herein.

Modifying the acoustic feature vectors by the user means that one or more elements in the acoustic feature vector are modified. The modified acoustic feature vector may then be combined with the encoder output as described above, to generate a modified speech signal.

FIG. 17 (b) shows a schematic illustration of training of the acoustic prediction network in the TTS system of FIG. 17 (a).

The training data comprises a target audio 1720 and corresponding text 1700. The training data may be the same data used to train the TTS system 1702. From the corresponding text 1700, a predicted mel spectrogram 1704 is obtained, by way of the TTS system 1702. A predicted acoustic feature vector is derived, by way of the acoustic prediction network 1608. From the target audio 1720, a target mel spectrogram 1721 is obtained. The difference between the target mel spectrogram 1721 and the predicted mel spectrogram 1704 is then obtained using an L1 (based on the absolute difference) or L2 (based on the squared differences) loss function and a first loss is obtained. The target audio 1720 is also analyzed in 1722 to obtain one or more target acoustic features. The difference between the target acoustic feature resulting from the analysis 1722 and the predicted acoustic feature vector from the acoustic prediction network 1608 is then obtained using an L1 or L2 loss and a second loss is obtained. The obtained first and second losses are added 1730 and the total loss is then backward propagated to update the weights of the acoustic prediction network.

Optionally, the TTS system 1702 is trained at the same time as the acoustic prediction network.

The acoustic feature analysis 1722 may comprise an analysis to obtain any one or more of pitch, intensity, formant, harmonicity, and spectral tilt. Each of these attributes may be obtained as described herein.

Alternative TTS Architecture: Transformer/Conformer Encoder

The encoder has been described previously as an RNN based network as described in relation to FIG. 3 (b), for example. However, as an alternative to the RNN based network, the encoder may instead comprise a conformer. Such an encoder may be referred to as a conformer encoder 18-23. The conformer encoder 18-23 is described below and illustrated in FIG. 18.

In an embodiment, the encoder module comprises a conformer. The conformer comprises self-attention layers. The conformer is more robust to received text having variable lengths. The conformer provides improved encoding of received text having long lengths. The effect of the conformer is to cause the synthesised speech to be more natural and realistic. The encoder module comprising a conformer may use used as an alternative to the encoder described previously herein. The encoder takes as input a text signal as described herein.

FIG. 18 shows a schematic illustration of an encoder 18-23. The encoder 18-23 is a conformer encoder. The encoder 18-23 is used in the prediction network 21, as described in relation to FIG. 3 (a). The encoder 18-23 takes as input a text signal. The text signal may comprise a sequence of characters or phonemes as described herein. The encoder 18-23 returns an encoder state.

The conformer encoder 18-23 comprises a first feed forward layer 18-231, a self-attention layer 18-233, a convolution layer 18-235, and a second feed forward layer 18-237. As shown in FIG. 18, the conformer 18-23 comprises said layers. Optionally, the conformer 18-23 comprises a stack of multiple blocks, where each block comprises said layers. Each block may be represented by the index n. There may be N blocks, where N is a whole number.

The first feed forward layer (FFL) 18-231 takes as input the text signal, for the first block n=1. For later blocks (n>1), the output from the previous block (n−1) is fed as input to the first FFL 18-231. The first feed forward layer 18-231 comprises two linear transformations and a nonlinear activation between them. A residual connection is added over the feed forward layers. Layer normalisation is applied to the input (text signal) within the residual unit before the first linear transformation. The nonlinear activation comprises a swish activation function (the swish function is defined as a×sigmoid(a)). The text signal is passed through the first FFL 18-231 with a half step residual connection.

The output of the first FFL 18-231 may be represented as:

\tilde{x}ₙ=xₙ+½FFN(xₙ),
where xₙ is the input into block n, and FFNO represents the first FFL. For the first block (n=1) or when there is only one block (N=1), xₙ corresponds to the text input. For later blocks (n>1), xₙ corresponds to the output from the previous block.

The output of the first feed forward layer 18-231 is directed to the self-attention layer 18-233. For example, the self-attention layer 18-233 may be a multi-headed self-attention (MSA) layer. The MSA layer 18-233 comprises layer normalisation followed by multi-head attention with relative positional embedding. Dropout may be used in training to regularise the model. The input to the MSA layer 18-233 is \tilde{x}ₙ. A residual connection is added over the layer normalisation and multi-head attention.

The multi-head attention with relative positional embedding is as follows. For ease of explanation, initially, the self-attention will be derived in relation to a single self-attention head. The derivation of self-attention for an input comprises the following steps:
(i) From the vector \tilde{x}ₙ inputted to the MSA layer 18-233, a query, a key, and a value matrix are obtained. These matrices are obtained by multiplying the input with corresponding weight matrices that are trained.
(ii) Obtain a score by multiplying the query and key matrices
(iii) Normalise the score
(iv) Multiply the value matrix by the normalised score

The relative positional embedding is performed together with the above steps and this is described further below.

The steps for deriving the self-attention may be represented mathematically as follows:

Zᵢⱼ^{rel}=Eₓⱼ^{T}W_{q}^{T}W_{k,E}Eₓⱼ+Eₓᵢ^{T}W_{q}^{T}W_{k,R}R_{i·j}+u^{T}W_{k,E}Eₓⱼ+v^{T}W_{k,R}Rᵢ₋ⱼ,

Where, the first term Eₓᵢ^{T}W_{q}^{T}W_{k,E}Eₓⱼ represents content based addressing, the second term Eₓᵢ^{T}W_{q}^{T}W_{k,R}Rᵢ₋ⱼ represents a content dependent positional bias, the third term u^{T}W_{k,E}Eₓⱼ governs global content bias, and the fourth term v^{T}W_{k,R}Rᵢ₋ⱼ represents a global positional bias. Rᵢ₋ⱼ is a relative positional embedding that is a sinusoid encoding matrix without learnable parameters. u^{T} and v^{T} are trainable parameters that corresponds to a query. W_{q} is a trainable weight matrix that is used for obtaining a obtaining a query. W_{k,E} and W_{k,R} are trainable weight matrices that is used for obtaining a key. Eₓᵢ is a matrix representing an embedding of the input.

When multiple attention heads are used, the above steps are performed separately for each head. Each attention head provides a separate output matrix Zᵢⱼ^{rel}. The separate output matrices are concatenated and multiplied with a further weight matrix trained jointly with the model. The resulting matrix is the output of the multi-headed self-attention.

Optionally, the number of attention heads used is 4 or 8. Although the above is described as multi-headed self-attention, it will be understood that, alternatively, a single attention head may be used.

The output of the MSA 18-233 may be represented as:

x′ₙ=\tilde{x}ₙ+MHSA(\tilde{x}ₙ),
where \tilde{x}ₙ is inputted into the MSA 18-233. \tilde{x}ₙ is the output of the first FFL 18-231. MHSA(.) represents the output of the multi-headed self-attention.

The convolution layer 18-235 takes the output of the MSA 18-233 as input. The convolution layer 18-235 comprises gating, by way of a point-wise convolution and a gated linear unit (GLU), followed by a 1D depthwise convolution layer. Batchnorm is deployed after convolution during training. The convolution kernel size may be any of 3, 7, 17, 32, or 65. For example, the kernel size is 32. A residual connection is added over the gating and convolution layer.

The output of the convolution layer 18-235 may be represented as:

x″ₙ=x′ₙ+Conv(x′ₙ),
where Conv(.) represents the convolution.

The second feedforward layer 18-237 takes the output of the convolution layer 18-235 as input. The second feedforward layer 18-237 is similar to the first feedforward layer 18-231, except that, in addition, layer normalisation is performed.

The output of the second feedforward layer 18-237 may be represented as:

yₙ=Layernorm(x″ₙ+½FFN(x″ₙ)),
where Layernorm(.) represents layer normalisation.

The output of a block n of the conformer encoder is the output of the second feedforward layer 18-237 of said block (yₙ). The output of the encoder module 18-23 is the output of the last block (n=N). The output of the encoder module 18-23 is also referred to as the encoder state.

In an alternative, the conformer encoder corresponds to that according to Gulati et al. “Conformer: Convolution-augmented transformer for speech recognition.” arXiv preprint arXiv:2005.08100 (2020).

While certain embodiments have been described, these embodiments have been presented by way of example only, and are not intended to limit the scope of the inventions. Indeed the novel methods and apparatus described herein may be embodied in a variety of other forms; furthermore, various omissions, substitutions and changes in the form of methods and apparatus described herein may be made.

1. A method of modifying a speech signal generated by a text-to-speech synthesiser, the method comprising:
receiving a text signal;
generating a speech signal from the text signal;
deriving a control feature vector, wherein the control feature vector represents modifications to the speech signal;
inputting the control feature vector in the text-to-speech synthesiser, wherein the text-to-speech synthesiser is configured to generate a modified speech signal using the control feature vector; and
outputting the modified speech signal;
wherein:
the text-to-speech synthesiser comprises a first model configured to generate the speech signal, and a controllable model configured to generate the modified speech signal; and
the controllable model is trained using speech signals generated by the first model.

2. A method according to claim 1, wherein deriving the control feature vector comprises:
analysing the speech signal;
obtaining a first feature vector from the analysed speech signal;
obtaining a user input; and
modifying the first feature vector using the user input to obtain the control feature vector.

3. A method according to claim 2, wherein the user input comprises a reference speech signal.

4. (canceled)

5. (canceled)

6. A method according to claim 1, wherein the controllable model comprises an encoder module, a decoder module, and an attention module linking the encoder module to the decoder module.

7. A method according to claim 6, wherein the first feature vector is inputted at the decoder module.

8. A method according to claim 7, wherein the first feature vector is modified by a pre net before being inputted at the decoder module of the controllable model.

9. A method according to claim 2, wherein the first feature vector represents one of the properties of pitch or intensity.

10. A method according to claim 1, the method further comprising deriving a second feature vector, wherein the second feature vector represents features of the generated speech signal that are used to generate the modified speech signal; and
inputting the second feature vector in the text-to-speech synthesiser, wherein the second feature vector is obtained from the analysed speech signal.

11. A method according to claim 10, wherein:
the controllable model comprises an encoder module, a decoder module, and an attention module linking the encoder module to the decoder module, and
the second feature vector is inputted at the decoder module of the controllable model.

12. A method according to claim 6, wherein a representation of the speech signal is inputted at the encoder module of the controllable model.

13. A method according to claim 6, wherein the method further comprises deriving a modified alignment from the user input, wherein the modified alignment indicates modifications to a timing of the speech signal.

14. A method according to claim 13, wherein the modified alignment is inputted at the attention module of the controllable model.

15. A method according to claim 6, wherein the first model comprises an encoder module, a decoder module, and an attention module linking the encoder module to the decoder module.

16. A method according to claim 15, the method further comprising:
deriving a third feature vector from the attention module of the first model, wherein the third feature vector corresponds to a timing of phonemes of the received text signal; and
inputting the third feature vector in the encoder module of the controllable model.

17. A system for modifying a speech signal generated by a text-to-speech synthesiser, the system comprising a processor and a memory, the processor being configured to:
receive a text signal;
generate a speech signal from the text signal;
derive a control feature vector, wherein the control feature vector represents modifications to the speech signal;
input the control feature vector in the text-to-speech synthesiser, wherein the text-to-speech synthesiser is configured to generate a modified speech signal using the control feature vector; and
output the modified speech signal;
wherein:
the text-to-speech synthesiser comprises a first model configured to generate the speech signal, and a controllable model configured to generate the modified speech signal; and
the controllable model is trained using speech signals generated by the first model.

18-47. (canceled)

48. A system according to claim 17, wherein the processor is further configured to:
analyse the speech signal;
obtain a first feature vector from the analysed speech signal;
obtain a user input; and
modify the first feature vector using the user input to obtain the control feature vector.

49. A system according to claim 48, wherein the user input comprises a reference speech signal.

50. A system according to claim 49, wherein the controllable model comprises an encoder module, a decoder module, and an attention module linking the encoder module to the decoder module.

51. A system according to claim 50, wherein the first feature vector is inputted at the decoder module.

52. A system according to claim 51, wherein the first feature vector is modified by a pre net before being inputted at the decoder module of the controllable model.
